(19) United States
(12) Patent Application Publication
(10) Pub. No.: US 2026/0250807 A1
(43) Pub. Date: Aug. 27, 2026

(54) METAL ALLOY AND COMPOSITIONS AND USES THEREOF

(71) Applicant: Phaseshift Technologies Inc., Toronto (CA)

(72) Inventors: Abu Anand, Toronto (CA); Gurjot Singh Dhaliwal, Toronto (CA); Fazal Mahmood Syed, Toronto (CA)

(21) Appl. No.: 19/545,863

(22) Filed: Feb. 20, 2026

Related U.S. Application Data
(60) Provisional application No. 63/761,206, filed on Feb. 21, 2025.

(51) Int. Cl. C22C 30/00; B22F 1/05; B22F 1/12; B22F 10/28; B33Y 10/00; B33Y 70/10; B33Y 80/00; C22C 29/06; C22C 29/08; C22C 32/00

(52) U.S. Cl. CPC C22C 30/00; B22F 1/05; B22F 1/12; B22F 10/28; B33Y 10/00; B33Y 70/10; B33Y 80/00; C22C 29/067; C22C 29/08; C22C 32/0052; B22F 2302/10; B22F 2304/10; B22F 2998/10; B22F 2999/00

(57) ABSTRACT

The present application relates to metal alloys. More specifically, the present application relates to metal alloys comprising nickel, cobalt and iron, and to powder blends thereof with a hard component portion comprising a hard component such as tungsten carbide. The present application also relates to uses thereof to form metal-matrix composites and metal-matrix composite products using, for example, additive manufacturing processes such as laser powder bed fusion (LPBF), and to the metal-matrix composites and metal-matrix composite products formed therefrom.

### RELATED APPLICATIONS

The present application claims the benefit of priority of co-pending U.S. provisional patent application No. 63/761,206 filed on Feb. 21, 2025, the contents of which are incorporated herein by reference in their entirety.

### FIELD

The present application relates to metal alloys. More specifically, the present application relates to a metal alloy comprising nickel, cobalt and iron, and to metal-matrix composites formed therefrom. For example, the metal-matrix composites are formed using additive manufacturing processes such as laser powder bed fusion (LPBF).

### BACKGROUND

The following is not an admission that anything discussed below is part of the prior art or part of the common general knowledge of a person skilled in the art.

Additive manufacturing or three-dimensional (3D) printing has developed rapidly over the last two decades. In additive manufacturing processes products are manufactured layer by layer which allows for increased manufacturing flexibility and complexity of design, and also enables the manufacturing of intricate products.

Laser powder bed fusion (LPBF) are additive manufacturing processes which use a laser beam as the energy source to melt the layers. LPBF has been applied in multiple industries including aerospace, biomedical, and automotive. However, there are certain drawbacks with LBPF when using conventional alloys and metal matrix composites such as cracking and pore formation. Therefore, there is a need for the development of improved material for use with LPBF.

### SUMMARY

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

Th present application includes a metal alloy comprising at least about 40 weight (wt) % of nickel (Ni) but not more than about 48 wt % of nickel (Ni), at least about 26 wt % cobalt (Co) and at least about 26% wt % of iron (Fe).

The present application also includes a metal alloy comprising
about 38 wt % to about 50 wt % of nickel (Ni);
about 25 wt % to about 31 wt % of cobalt (Co); and
about 25 wt % to about 31 wt % of iron (Fe),
wherein all wt % are based on the total weight of the metal alloy.

In some embodiments, the metal alloy comprises
about 40 wt % to about 48 wt % of nickel (Ni);
about 25 wt % to about 30 wt % of cobalt (Co); and
about 25 wt % to about 30 wt % of iron (Fe), all wt % based on the total weight of the metal alloy.

In some embodiments, the metal alloy comprises
about 44 wt % to about 48 wt % of nickel (Ni);
about 25 wt % to about 28 wt % of cobalt (Co); and
about 25 wt % to about 28 wt % of iron (Fe), all wt % based on the total weight of the metal alloy.

The present application also includes a hard component portion-metal alloy powder blend comprising
about 0.5 wt % to about 95 wt % of a hard component portion; and
about 5 wt % to about 99.5 wt % of the metal alloy of the alloy of the application,
wherein all wt % are based on total weight of the hard component portion-metal alloy powder blend.

In some embodiments, the hard component portion-metal alloy powder of the application, comprises
about 50 wt % to about 95 wt % of the hard component portion; and
about 5 wt % to about 50 wt % of the metal alloy, wherein all wt % based on total weight of the hard component carbide)-metal alloy powder blend.

In some embodiments, the hard component portion-metal alloy powder blend of the application, comprises
about 0.5 wt % to about 70 wt % of the hard component portion and
about 30 wt % to about 99.5 wt % of the metal alloy,
wherein all wt % based on total weight of the hard component portion-metal alloy powder blend.

In some embodiments, the hard component portion comprises about 75 wt % to about 95 wt % of a hard component and about 5 wt % to about 25 wt % of the metal alloy metal alloy of the application, or one or more elemental metals selected from Ni, Co and Fe, or mixtures thereof, wherein at wt % are based on the total weight of the hard component portion, optionally wherein the hard component portion comprises about 80 wt % to about 95 wt % of the hard component, and about 5 wt % to about 15 wt % of elemental Ni, wherein all wt % are based on the total weight of the hard component portion.

In some embodiments, the hard component is tungsten carbide.

The present application also includes a metal matrix composite (MMC) comprising the metal alloy of the application.

In some embodiments, the MCC is a laser powder bed fusion (LPBF) additively manufactured MMC product prepared from the hard component portion-metal alloy powder blend of the application.

The present application also includes a method of LPBF additive manufacturing a metal matrix composite (MMC) product of the application comprising:
providing a metal alloy powder of the application or hard component portion-metal alloy powder blend of the application as a feedstock material in a LPBF apparatus, and
LPBF additively manufacturing the MMC product, optionally

In some embodiments, the present application comprises, consists, or consists essentially of any of the embodiments described herein.

Other features and advantages of the present application will become apparent from the following detailed description. It should be understood, however, that the detailed description and the specific examples, while indicating embodiments of the application, are given by way of illustration only and the scope of the claims should not be limited by these embodiments, but should be given the broadest interpretation consistent with the description as a whole.

### BRIEF DESCRIPTION OF DRAWINGS

The embodiments of the application will now be described in greater detail with reference to the attached drawings in which:

FIG. 1 shows a flowchart showing the process of preparing the metal alloy, metal-metal alloy powder blend and metal matrix composites of the application.

FIG. 2 shows a photo of an exemplary metal alloy of the application after being casted as a rod.

FIG. 3 shows an scanning electron microscopy (SEM) image of an exemplary metal alloy of the application after being casted as a rod.

FIG. 4 shows an energy-dispersive X-ray spectroscopy diagram of an exemplary metal alloy of the application after being casted as a rod and heat treated.

FIG. 5 shows scanning electron microscopy (SEM) images of the an exemplary metal alloy powder of the application produced after atomization. (A) shows SEM images of exemplary metal alloy powder particles produced after atomization; (B) shows SEM images of a polished cross section of an exemplary metal alloy powder particle; and (C) shows a magnified SEM image of a polished cross section of an exemplary metal alloy powder particle.

FIG. 6 shows SEM images of tungsten carbide (WC) powder.

FIG. 7 shows images of representative laser powder bed fusion (LPBF) manufactured cubes using exemplary metal alloys of the application or WC portion-metal alloy blends of the application. (A) LPBF manufactured cubes using 100 wt % of an exemplary metal alloy powder of the application, (B) LPBF manufactured cubes using exemplary 10 wt % WC-metal alloy blend of the application, (C) LPBF manufactured cubes using exemplary 30 wt % WC-metal alloy blend of the application, and (D) LPBF manufactured cubes using exemplary 50 wt % of 90 wt % WC/10 wt % Ni-metal alloy blend of the application.

FIG. 8 shows the hardness values for exemplary LPBF manufactured metal matrix composites (MMCs) of the application using various exemplary WC portion-metal alloy powder blends of the application with increasing amounts of WC as follows: metal allow powder alone (0% WC), 10 wt % WC-metal alloy powder, 30 wt % WC-metal alloy powder, 50 wt % Ni spray coated WC powder (WallCarb™ 90/10)-metal alloy powder and 65 wt % Ni spray coated WC powder (WallCarb™ 90/10)-metal alloy powder.

FIG. 9 is a table showing the comparative wear testing results for comparative materials, Kar85™ (first column), KAC89™ (second column), Vibenite™ 480 (third column),), and H13 tool steel (eight column), and exemplary LPBF manufactured MMCs of the application prepared from a 65 wt % Ni spray coated WC powder (WallCarb™ 90/10)-ultrasonically atomized metal allow powder blend (fourth and fifth column) of the application, and a 65 wt % Ni spray coated WC powder (WallCarb™ 90/10)-commercially gas atomized metal alloy powder blend of the application (sixth and seventh column).

FIG. 10 shows exemplary LPBF manufactured MMCs prepared from a 65 wt % Ni spray coated WC powder (WallCarb™ 90/10)-gas atomized metal alloy powder of the application. (A) exemplary LPBF manufactured MMCs having cubic geometries (B) larger design LPBF manufactured MMCs.

FIG. 11 shows the scanning electron microscope image of the cross section of a nozzle printed using an exemplary 65 wt % Ni spray coated WC powder (WallCarb™ 90/10)-gas atomized metal alloy powder of the application.

FIG. 12 shows a scanning electron micrograph of the as-printed microstructure of a nozzle printed using an exemplary 65 wt % Ni spray coated WC powder (WallCarb™ 90/10)-gas atomized metal alloy powder of the application. The bright regions correspond to WC particles, while the darker continuous phase represents the FCC metal matrix.

### DETAILED DESCRIPTION

### I. Definitions

Numerous embodiments are described in this application and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with modification and alteration without departing from the teachings disclosed herein. Although particular features of the present invention may be described with reference to one or more particular embodiments or figures, it should be understood that such features are not limited to usage in the one or more particular embodiments or figures with reference to which they are described.

Unless otherwise indicated, the definitions and embodiments described in this and other sections are intended to be applicable to all embodiments and aspects of the present application herein described for which they are suitable as would be understood by a person skilled in the art.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise

As used in this application and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The term “consisting” and its derivatives as used herein are intended to be closed terms that specify the presence of the stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

Terms of degree such as “substantially”, “about” and “approximately” as used herein mean a reasonable amount of deviation of the modified term such that the end-result is not significantly changed. These terms of degree should be construed as including a deviation of at least ±5% of the modified term if this deviation would not negate the meaning of the word it modifies.

The term “and/or” as used herein means that the listed items are present, or used, individually or in combination. In effect, this term means that “at least one of” or “one or more” of the listed items is used or present.

As used in the present application, the singular forms “a”, “an” and “the” include plural references unless the content clearly dictates otherwise.

In embodiments comprising an “additional” or “second” component, the second component as used herein is different from the other components or first component. A “third” component is different from the other, first, and second components, and further enumerated or “additional” components are similarly different.

The term “suitable” as used herein means that the selection of the particular compound, composition or conditions would depend on the specific steps to be performed, the identity of the components to be transformed and/or the specific use for the compositions, but the selection would be well within the skill of a person trained in the art.

The term “metal mixture of the application” and the like as used herein refers to metal mixture comprising nickel, cobalt and iron as described herein.

The term “metal alloy of the application” and the like as used herein refers to metal alloys comprising nickel, cobalt and iron as described herein.

The term “metal alloy powder of the application” and the like as used herein refers to a powder material formed from the metal alloy of the application.

The term “hard component portion-metal alloy powder blend of the application” and the like as used herein refers to a blend comprising a hard component portion and a metal alloy powder of the application.

The term “hard component portion” as used herein refers to hard component alone or a hard component in combination with the metal alloy or one or more elemental metals, or mixtures thereof as described herein.

The term “hard component” as used herein refers to a component in a material that imparts hardness to the material.

The term “tungsten carbide portion-metal alloy powder blend of the application” and the like as used herein refers to a hard component portion-metal alloy powder blend of the application wherein the hard component portion is a tungsten carbide portion.

The term “tungsten carbide portion” as used herein refers to tungsten carbide alone or a tungsten carbide in combination with the metal alloy of the application or one or more elemental metals, or mixtures thereof as described herein.

The term “metal matrix composite of the application” or “MMC of the application” and the like as used herein refers to a metal matrix composite (MMC) formed from the hard component portion-metal alloy powder blend of the application. MMC as used herein includes cemented carbides.

The term “laser powder bed fusion manufactured product of the application” or “LPBF manufactured product of the application” or “LPBF manufactured MMC product of the application” and the like as used herein refers to a product manufactured by laser powder bed fusion additive manufacturing using the hard component-metal alloy powder blend of the application.

The term “laser powder bed fusion” refers to additive manufacturing process that uses a laser beam to melt a powder material together.

The term “additive manufacturing” refers to processes for forming a three-dimensional object by successively adding material to the object layer by layer. Additive manufacturing may also be referred to as three-dimensional (3D) printing.

The term “D₁₀” as used herein refers the diameter value for the particles in a material at which about 10% of the particles have a diameter below the diameter value.

The term “D₅₀” as used herein refers the diameter value for the particles in a material at which about 50% of the particles have a diameter below the diameter value.

The term “D₉₀” as used herein refers the diameter value for the particles in a material at which about 90% of the particles have a diameter below the diameter value.

Further, although method steps may be described (in the disclosure and/or in the claims) in a sequential order, such methods may be configured to work in alternate orders. In other words, any sequence or order of steps that may be described does not necessarily indicate a requirement that the steps be performed in that order. The steps of methods described herein may be performed in any order that is practical. Further, some steps may be performed simultaneously.

### II. Metal Alloy and Compositions Thereof of the Application

Laser powder bed fusion (LPBF) is a type of additive manufacturing (AM) process that uses a high-powered laser to selectively melt a powder composition layer by layer to create a three-dimensional (3-D) product. This technique allows for the production of complex and intricate geometries with high precision that would normally be difficult or impossible to achieve with traditional manufacturing methods. LPBF offers high design flexibility and material efficiency, with applications in various fields and industries such as, for example, the metalworking and machining, aerospace, automotive, tooling and manufacturing and medical fields.

Metal matrix composites (MMCs) including cemented carbides and cermets generally comprise hard components like hard ceramic particles (traditionally tungsten carbide/WC) embedded in a metal binder (traditionally cobalt (Co)). The carbide particles are generally known to provide hardness, wear resistance, and high-temperature stability, making the material useful for demanding applications like cutting tools and wear-resistant components. The metal binder is generally known to add toughness and ductility, preventing the otherwise brittle carbide from fracturing under impact or stress by holding the carbide particles together and absorbing shock. This combination results in a composite material with both hardness and toughness, capable of performing under extreme conditions.

Additive manufacturing (e.g. 3-D printing) of MMCs such as cemented carbides through LPBF presents several challenges due to the unique properties of both the carbide particles and the metal binder. For example, tungsten carbide (WC) and other carbides have significantly higher melting points than the metal binder which can result in non-uniform melting, causing defects during manufacturing. Further, MMCs such as cemented carbides are prone to thermal cracking due to the mismatch in thermal expansion between the hard carbide particles and the more ductile metal binder. During LPBF, the rapid heating and cooling cycles can induce high residual stresses, leading to cracking or distortion in the printed product. Further still, maintaining a high density in the printed product is important to structural integrity and good mechanical performance. However, LPBF often produces products with internal porosity when composite materials like MMCs such as cemented carbides which were primarily designed for use with another processes such as sintering, hot isostatic pressing, and cladding are used.

A novel metal alloy comprising nickel, cobalt and iron has been developed. In some embodiments, the metal alloy was designed, for example, to make additive manufacturing, (such as LPBF) more efficient, reliable, and capable of producing high-density products such as MMCs with fewer defects. In some embodiments, it has been shown that the metal alloy can be used as a metal binder alloy along with a hard component in the preparation of MMCs using, for example, additive manufacturing processes such as LPBF. The novel metal alloy was found to have improved structural and mechanical properties which address some of the inherent challenges associated with LPBF manufacturing of MMCs such as cemented carbides described above. For example, calculated thermodynamic phase diagrams using Calculation of Phase Diagrams (CALPHAD) have indicated that metal alloys of the application comprise a stable single phase of structure, particularly a single phase of face centered cubic (fcc) structure and a narrow solidus-liquidus interval which is advantageous, for example, for use with the rapid and repeated heating and cooling cycles of the LPBF. The single phase structure, particularly a single phase of face centered cubic (fcc), was also shown using scanning electron micrographs.

The metal alloys were used as a feedstock material to provide a LPBF additively manufactured product, or MMCs were produced from the blends of a powder of the metal alloy of the application and a hard component portion such as tungsten carbide alone, or tungsten carbide that was processed (e.g. spray dried) with the metal alloy or one or more elemental metals such as Ni. Blends of the metal alloy powder of the application and a hard component/hard component portion like carbides such as tungsten carbide or Ni spray dried tungsten carbide can be used as to form MMCs using conventional techniques. In some embodiments, the blends of the application were used as feedstock material for LPBF to provide an in situ formed MMC (e.g. cemented carbide) and 3-D printed MMC (e.g. cemented carbide) products.

The improved properties of the metal alloy of the application extended to products formed therefrom to also provide products with improved structural and mechanical properties, such as improved homogeneity of structure, improved density, decreased porosity, improved strength, improved crack resistance and compared to, for example, comparable LPBF manufactured MMC products using conventional binder such as those comprising a strictly Co binder. It has been shown that blends comprising the exemplary metal alloy powders of the application in combination with with tungsten carbide or Ni spray dried tungsten carbide exhibited improved additive manufacturability. For example, the blends of the application were shown to produce additively manufactured MMC products with very high density values with little or no cracking and few defects, which is consistent with effective melting and wetting of the exemplary blends of the application, uniform solidification, strong layer fusion and low porosity. The LPBF manufactured MMCs of the application using the metal alloy of the application were also shown to have improved wear resistance, indicating that they achieve an effective balance between hardness and toughness. For example, in an embodiment, where the LPBF manufactured MMCs were intended a nozzles for use in the oil and gas industry, wear resistance testing showed that the LPBF manufactured MMCs prepared from an exemplary blend of 35 wt % of the metal alloy powder of the application and 65 wt % Ni spray dried tungsten carbide (containing 90 wt % tungsten carbide/10 wt % Ni) performed better than other commercially available material comprising 65 wt % tungsten carbide, and further performed comparable to or better to commercially available material comprising higher tungsten carbide content.

### Metal Alloy of the Application

Accordingly, the present application includes a metal alloy comprising at least about 34 atomic % of nickel (Ni) but not more than about 58 atomic % of nickel (Ni), at least about 21 atomic % cobalt (Co) and at least about 21% atomic % of iron (Fe).

In some embodiments, the metal alloy comprises at least about 34, about 35, about 36, about 37, about 38, about 39, about 40, about 41, about 42, about 43, about 44, about 45, about 46, about 47, about 48, about 49 about 50, about 51, about 52, about 53, about 54, about 56, about 57 or about 58 atomic % of Ni. In some embodiments, the metal alloy comprises at least about 34, about 35, about 36, about 37, about 38, about 39, about 40, about 41, about 42, about 43, about 44, about 45, about 46, about 47, about 48, about 49, about 50, about 51, about 52, about 53, or about 54 atomic % of Ni. In some embodiments, the metal alloy comprises at least about 38, about 39, about 40, about 41, about 42, about 43, about 44, about 45, about 46, about 47, about 48, about 49 or about 50 atomic % of Ni, In some embodiments, the metal alloy comprises at least about 40, about 41, about 42, about 43, about 44, about 45, about 46, about 47 or about 48 atomic % of Ni. In some embodiments, the metal alloy comprises at least about 42, about 43, about 44, about 45, about 46 atomic % of Ni.

In some embodiments, the metal alloy comprises at least about 22, about 23, about 24, about 25, about 26, about 27, about 28, about 29, about 30, about 31, about 32 or about 33 atomic % Co. In some embodiments, the metal alloy comprises at least about 25, about 26, about 27, about 28, about 29, about 30 or about 31 atomic % Co.

In some embodiments, the metal alloy comprises at least about 22, about 23, about 24, about 25, about 26, about 27, about 28, about 29, about 30, about 31, about 32 or about 33 atomic % Fe. In some embodiments, the metal alloy comprises at least about 25, about 26, about 27, about 28, about 29, about 30 or about 31 atomic % Fe.

In some embodiments, the metal alloy comprises at least about 34 atomic % of nickel (Ni) but not more than about 54 atomic % of nickel (Ni), at least about 23 atomic % cobalt (Co) and at least about 23% atomic % of iron (Fe). In some embodiments, the metal alloy comprises at least about 38 atomic % of nickel (Ni) but not more than about 50 atomic % of nickel (Ni), at least about 25 atomic % cobalt (Co) and at least about 25% atomic % of iron (Fe). In some embodiments, the metal alloy comprises at least about 40 atomic % of nickel (Ni) but not more than about 48 atomic % of nickel (Ni), at least about 26 atomic % cobalt (Co) and at least about 26% atomic % of iron (Fe). In some embodiments, the metal alloy comprises at least about 42 atomic % of nickel (Ni) but not more than about 48 atomic % of nickel (Ni), at least about 26 atomic % cobalt (Co) and at least about 26% atomic % of iron (Fe). In some embodiments, the metal alloy comprises at least about 42 atomic % of nickel (Ni) but not more than about 46 atomic % of nickel (Ni), at least about 27 atomic % cobalt (Co) and at least about 27% atomic % of iron (Fe).

In some embodiments, in the metal alloy powder, the Ni is present in a greater atomic % compared to the atomic % of the Co or the Fe.

In some embodiments, the Ni, Co and Fe are present in the metal alloy in an atomic percent ratio of about 1-2.4:1:1, about 1.2-2:1:1, about 1.3-1.8:1:1, about 1.4-1.7:1:1, about 1.4-1.6:1:1 or about 1.5-1.6:1:1. In some embodiments, the Ni, Co and Fe are present in the metal alloy in an atomic percent ratio of about 1-2.4:1:1, about 1.2-2:1:1, about 1.3-1.8:1:1, about 1.4-1.6:1:1 or about 1.5-1.6:1:1. In some embodiments, the Ni, Co and Fe are present in the metal alloy in an atomic percent ratio of about 1.3-1.8:1-1.2:1, about 1.3-1.7:1-1.2:1, or about 1.4-1.7:1-1.1:1.

In some embodiments, the application includes a metal alloy comprising
about 34 atomic % to about 58 atomic % of nickel (Ni);
about 21 atomic % to about 33 atomic % of cobalt (Co); and
about 21 atomic % to about 33 atomic % of iron (Fe).

In some embodiments, the metal alloy comprises about 34 (optionally, about 35, about 36, about 37, about 38, about 39, about 40, about 41, about 42, about 43, about 44, about 45, about 46, about 47, about 48, about 49, about 50, about 51, about 52, about 53, about 54, about 55, about 56, about 57) to about 58 atomic % Ni; In some embodiments, the metal alloy comprises about 34 (optionally, about 35, about 36, about 37, about 38, about 39, about 40, about 41, about 42, about 43, about 44, about 45, about 46, about 47, about 48, about 49, about 50, about 51, about 52, about 53, about 54, about 55) to about 56 atomic % Ni; about 34 (optionally, about 35, about 36, about 37, about 38, about 39, about 40, about 41, about 42, about 43, about 44, about 45, about 46, about 47, about 48, about 49, about 50, about 51, about 52, about 53) to about 54 atomic % Ni; about 35 (optionally, about 36, about 37, about 38, about 39, about 40, about 41, about 42, about 43, about 44, about 45, about 46, about 47, about 48, about 49, about 50, about 51 or about 52) to about 53 atomic % Ni; about 36 (optionally, about 37, about 38, about 39, about 40, about 41, about 42, about 43, about 44, about 45, about 46, about 47, about 48, about 49, about 50 or about 51) to about 52 atomic % Ni; about 37 (optionally, about 38, about 39, about 40, about 41, about 42, about 43, about 44, about 45, about 46, about 47, about 48, about 49 or about 50) to about 51 atomic % Ni; about 38 (optionally, about 39, about 40, about 41, about 42, about 43, about 44, about 45, about 46, about 47, about 48 or about 49) to about 50 atomic % Ni; about 39 (optionally, about 40, about 41, about 42, about 43, about 44, about 45, about 46, about 47 or about 48) to about 49 atomic % Ni; about 40 (optionally about 41, about 42, about 43, about 44, about 45, about 46 or about 47) to about 48 atomic % Ni; about 41 (optionally, about 42, about 43, about 44, about 45 or about 46) to about 47 atomic % Ni, about 42 (optionally, about 43, about 44, about 45) to about 46 atomic % Ni; about 43 (optionally, about 44) to about 45 atomic % of Ni or about 42 (optionally about 43, about 44, about 45, about 46 or about 47) to about 48 atomic % of Ni.

In some embodiments, the metal alloy comprises about 34 (optionally, about 35, about 36, about 37, about 38, about 39, about 40, about 41, about 42, about 43, about 44, about 45, about 46, about 47, about 48, about 49, about 50, about 51, about 52 or about 53) to about 54 atomic % Ni; about 35 (optionally, about 36, about 37, about 38, about 39, about 40, about 41, about 42, about 43, about 44, about 45, about 46, about 47, about 48, about 49, about 50, about 51 or about 52) to about 53 atomic % Ni; about 36 (optionally, about 37, about 38, about 39, about 40, about 41, about 42, about 43, about 44, about 45, about 46, about 47, about 48, about 49, about 50 or about 51) to about 52 atomic % Ni; about 37 (optionally, about 38, about 39, about 40, about 41, about 42, about 43, about 44, about 45, about 46, about 47, about 48, about 49 or about 50) to about 51 atomic % Ni; about 38 (optionally, about 39, about 40, about 41, about 42, about 43, about 44, about 45, about 46, about 47, about 48 or about 49) to about 50 atomic % Ni; about 39 (optionally, about 40, about 41, about 42, about 43, about 44, about 45, about 46, about 47 or about 48) to about 49 atomic % Ni; about 40 (optionally about 41, about 42, about 43, about 44, about 45, about 46 or about 47) to about 48 atomic % Ni; about 41 (optionally, about 42, about 43, about 44, about 45 or about 46) to about 47 atomic % Ni, about 42 (optionally, about 43, about 44, about 45) to about 46 atomic %; about 43 (optionally, about 44) to about 45 atomic % of Ni. In some embodiments, the metal alloy comprises about 38 (optionally, about 39, about 40, about 41, about 42, about 43, about 44, about 45, about 46, about 47, about 48 or about 49) to about 50 atomic % Ni, about 40 (optionally about 41, about 42, about 43, about 44, about 45, about 46 or about 47) to about 48 atomic % Ni; about 41 (optionally, about 42, about 43, about 44, about 45 or about 46) to about 47 atomic % Ni, about 42 (optionally, about 43, about 44, about 45) to about 46 atomic %; about 43 (optionally about 44) to about 45 atomic % Ni. In some embodiments, the metal alloy comprises about 38 (optionally, about 39, about 40, about 41, about 42, about 43, about 44, about 45, about 46, about 47, about 48 or about 49) to about 50 atomic % N, about 40 (optionally about 41, about 42, about 43, about 44, about 45, about 46 or about 47) to about 48 atomic % Ni or about 42 (optionally, about 43, about 44, about 45) to about 46 atomic % Ni; or about 43 (optionally about 44) to about 45 atomic % Ni. In some embodiments, the metal alloy comprises about 40 (optionally about 41, about 42, about 43, about 44, about 45, about 46 or about 47) to about 48 atomic % Ni; about 41 (optionally, about 42, about 43, about 44, about 45 or about 46) to about 47 atomic % Ni, about 42 (optionally about 43, about 44, about 45, about 46 or about 47) to about 48 atomic % of Ni; about 42 (optionally, about 43, about 44, about 45) to about 46 atomic % Ni; about 43 (optionally, about 44, about 45 or about 46) to about 47 atomic % of Ni; about 44 (optionally, about 44) to about 46 atomic % of Ni.

In some embodiments, the metal alloy comprises about 34, about 35, about 36, about 37, about 38, about 39, about 40, about 41, about 42, about 43, about 44, about 45, about 46, about 47, about 48, about 49, about 50, about 51, about 52, about 53, about 54, about 55, about 56, about 57 or about 58 atomic % Ni. In some embodiments, the metal alloy comprises about 34, about 35, about 36, about 37, about 38, about 39, about 40, about 41, about 42, about 43, about 44, about 45, about 46, about 47, about 48, about 49, about 50, about 51, about 52, about 53 or about 54 atomic % Ni. In some embodiments, the metal alloy comprises about 38, about 40, about 42, about 44, about 46, about 48, or about 50 atomic % Ni. In some embodiments, the metal alloy comprises about 40, about 42, about 44, about 46 or about 48 atomic % Ni. In some embodiments, the metal alloy comprises about 42, about 44 or about 46 atomic % Ni.

In some embodiments, the metal alloy comprises about 21 (optionally, about 22, about 23, about 24, about 25, about 26, about 27, about 28, about 29, about 30, about 31, about 32, about 33, about 34) to about 33 atomic % Co; about 23 (optionally, about 24, about 25, about 26, about 27, about 28, about 29, about 30, about 31 or about 32) to about 33 atomic % Co; about 24 (optionally, about 25, about 26, about 27, about 28, about 29, about 30, or about 31) to about 32 atomic % Co; about 25 (optionally, about 26, about 27, about 28, about 29 or about 30) to about 31 atomic % Co, about 26 (optionally, about 27, about 28 or about 29) to about 30 atomic % Co; or about 27 (optionally, about 28) to about 29 atomic % Co. In some embodiments, the metal alloy comprises about 24 (optionally, about 25, about 26, about 27, about 28, about 29, about 30, or about 31) to about 32 atomic % Co; about 25 (optionally, about 26, about 27, about 28, about 29 or about 30) to about 31 atomic % Co; about 26 (optionally, about 27, about 28 or about 29) to about 30 atomic % Co; or about 27 (optionally, about 28) to about 29 atomic % Co. In some embodiments, the metal alloy comprises about 25 (optionally, about 26, about 27, about 28, about 29 or about 30) to about 31 atomic % Co; about 26 (optionally, about 27, about 28 or about 29) to about 30 atomic % Co; or about 27 (optionally, about 28) to about 29 atomic % Co. In some embodiments, the metal alloy comprises about 25 (optionally, about 26, about 27, about 28, about 29 or about 30) to about 31 atomic % Co; about 25 (optionally, about 26, about 27, about 28, or about 29) to about 30 atomic % Co; about 25 (optionally, about 26, about 27, or about 28) to about 29 atomic % Co; about 25 (optionally, about 26 or about 27) to about 28 atomic % Co; about 25 (optionally, about 26) to about 27 atomic % Co; about 26 (optionally, about 27) to about 28 atomic % Co; or about 26 (optionally, about 27 or about 28) to about 29 atomic % Co.

In some embodiments, the metal alloy comprises about 21, about 22, about 23, about 24, about 25, about 26, about 27, about 28, about 29, about 30, about 31, about 32 or about 33, atomic % Co. In some embodiments, the metal alloy comprises about 23, about 24, about 25, about 26, about 27, about 28, about 29, about 30, about 31, about 32 or about 33 atomic % Co. In some embodiments, the binder comprises about 24, about 25, about 26, about 27, about 28, about 29, about 30, about 31 or about 32 atomic % Co. In some embodiments, the metal alloy comprises about 25, about 26, about 27, about 28, about 29, about 30 or about 31 atomic % Co. In some embodiments, the metal alloy comprises about 25, about 26, about 27, about 28, or about 29 atomic % Co.

In some embodiments, the metal alloy comprises about 21 (optionally, about 22, about 23, about 24, about 25, about 26, about 27, about 28, about 29, about 30, about 31, about 32, about 33, about 34) to about 33 atomic % Fe; about 23 (optionally, about 24, about 25, about 26, about 27, about 28, about 29, about 30, about 31 or about 32) to about 33 atomic % Fe; about 24 (optionally, about 25, about 26, about 27, about 28, about 29, about 30, or about 31) to about 32 atomic % Fe; about 25 (optionally, about 26, about 27, about 28, about 29 or about 30) to about 31 atomic % Fe, about 26 (optionally, about 27, about 28 or about 29) to about 30 atomic % Fe; or about 27 (optionally, about 28) to about 29 atomic % Fe. In some embodiments, the metal alloy comprises about 24 (optionally, about 25, about 26, about 27, about 28, about 29, about 30, or about 31) to about 32 atomic % Fe; about 25 (optionally, about 26, about 27, about 28, about 29 or about 30) to about 31 atomic % Fe; about 26 (optionally, about 27, about 28 or about 29) to about 30 atomic % Fe; or about 27 (optionally, about 28) to about 29 atomic % Fe. In some embodiments, the metal alloy comprises about 25 (optionally, about 26, about 27, about 28, about 29 or about 30) to about 31 atomic %; about 26 (optionally, about 27, about 28 or about 29) to about 30 atomic % Fe; or about 27 (optionally, about 28) to about 29 atomic % Fe. In some embodiments, the metal alloy comprises about 25 (optionally, about 26, about 27, about 28, about 29 or about 30) to about 31 atomic % Fe; about 25 (optionally, about 26, about 27, about 28, or about 29) to about 30 atomic % Fe; about 26 (optionally, about 27, about 28, about 29 or about 30) to about 31 atomic % Fe; about 26 (optionally, about 27, about 28, or about 29) to about 30 atomic % Fe; about 26 (optionally, about 27, about 28 or about 29) to about 29 atomic % Fe.

In some embodiments, the metal alloy comprises about 21, about 22, about 23, about 24, about 25, about 26, about 27, about 28, about 29, about 30, about 31, about 32 or about 33 atomic % Fe. In some embodiments, the metal alloy comprises about 23, about 24, about 25, about 26, about 27, about 28, about 29, about 30, about 31, about 32 or about 33 atomic % Fe. In some embodiments, the metal alloy comprises about 24, about 25, about 26, about 27, about 28, about 29, about 30, about 31 or about 32 atomic % Fe. In some embodiments, the metal alloy comprises about 25, about 26, about 27, about 28, about 29, about 30 or about 31 atomic % Fe. In some embodiments, the metal alloy comprises about 25, about 26, about 27, about 28, about 29 about 30 or about 31 atomic % Fe.

In some embodiments, the application includes a metal alloy comprising
about 34 atomic % to about 54 atomic % of nickel (Ni);
about 23 atomic % to about 33 atomic % of cobalt (Co); and
about 23 atomic % to about 33 atomic % of iron (Fe).

In some embodiments, the application includes a metal alloy comprising
about 38 atomic % to about 50 atomic % of nickel (Ni);
about 25 atomic % to about 31 atomic % of cobalt (Co); and
about 25 atomic % to about 31 atomic % of iron (Fe).

In some embodiments, the application includes a metal alloy comprising
about 40 atomic % to about 48 atomic % of nickel (Ni);
about 26 atomic % to about 30 atomic % of cobalt (Co); and
about 26 atomic % to about 30 atomic % of iron (Fe).

In some embodiments, the application includes a metal alloy comprising
about 40 atomic % to about 48 atomic % of nickel (Ni);
about 25 atomic % to about 30 atomic % of cobalt (Co); and
about 25 atomic % to about 30 atomic % of iron (Fe).

In some embodiments, the application includes a metal alloy comprising
about 42 atomic % to about 48 atomic % of nickel (Ni);
about 25 atomic % to about 29 atomic % of cobalt (Co); and
about 25 atomic % to about 29 atomic % of iron (Fe).

In some embodiments, the application includes a metal alloy comprising
about 42 atomic % to about 46 atomic % of nickel (Ni);
about 27 atomic % to about 29 atomic % of cobalt (Co); and
about 27 atomic % to about 29 atomic % of iron (Fe).

In some embodiments, the application includes a metal alloy comprising
about 44 atomic % to about 48 atomic % of nickel (Ni);
about 25 atomic % to about 28 atomic % of cobalt (Co); and
about 25 atomic % to about 28 atomic % of iron (Fe).

In some embodiments, the application includes a metal alloy comprising
about 44 atomic % to about 46 atomic % of nickel (Ni);
about 26 atomic % to about 28 atomic % of cobalt (Co); and
about 26 atomic % to about 28 atomic % of iron (Fe).

In some embodiments, the application includes a metal alloy comprising
about 42 atomic % to about 45 atomic % of nickel (Ni);
about 27 atomic % to about 28 atomic % of cobalt (Co); and
about 28 atomic % to about 30 atomic % of iron (Fe).

In some embodiments, the application includes a metal alloy comprising
about 44 atomic % of nickel (Ni);
about 28 atomic % of cobalt (Co); and
about 28 atomic % of iron (Fe).

In some embodiments, the application includes a metal alloy comprising
about 46 atomic % of nickel (Ni);
about 26 atomic % of cobalt (Co); and
about 28 atomic % of iron (Fe).

The present application also includes a metal alloy comprising at least about 34 weight (wt) % of nickel (Ni) but not more than about 58 wt % of nickel (Ni), at least about 21 wt % cobalt (Co) and at least about 21% wt % of iron (Fe), based on the total weight of the metal alloy.

In some embodiments, the metal alloy comprises at least about 34, about 35, about 36, about 37, about 38, about 39, about 40, about 41, about 42, about 43, about 44, about 45, about 46, about 47, about 48, about 49 about 50, about 51, about 52, about 53, about 54, about 56, about 57 or about 58 wt % of Ni. In some embodiments, the metal alloy comprises at least about 34, about 35, about 36, about 37, about 38, about 39, about 40, about 41, about 42, about 43, about 44, about 45, about 46, about 47, about 48, about 49, about 50, about 51, about 52, about 53, or about 54 wt % of Ni, based on the total weight of the metal alloy. In some embodiments, the metal alloy comprises at least about 38, about 39, about 40, about 41, about 42, about 43, about 44, about 45, about 46, about 47, about 48, about 49 or about 50 wt % of Ni, based on the total weight of the metal alloy. In some embodiments, the metal alloy comprises at least about 40, about 41, about 42, about 43, about 44, about 45, about 46, about 47 or about 48 wt % of Ni, based on the total weight of the metal alloy. In some embodiments, the metal alloy comprises at least about 42, about 43, about 44, about 45, about 46 wt % of Ni, based on the total weight of the metal alloy.

In some embodiments, the metal alloy comprises at least about 22, about 23, about 24, about 25, about 26, about 27, about 28, about 29, about 30, about 31, about 32 or about 33 wt % Co, based on the total weight of the metal alloy. In some embodiments, the metal alloy comprises at least about 25, about 26, about 27, about 28, about 29, about 30 or about 31 wt % Co, based on the total weight of the metal alloy.

In some embodiments, the metal alloy comprises at least about 22, about 23, about 24, about 25, about 26, about 27, about 28, about 29, about 30, about 31, about 32 or about 33 wt % Fe, based on the total weight of the metal alloy. In some embodiments, the metal alloy comprises at least about 25, about 26, about 27, about 28, about 29, about 30 or about 31 wt % Fe, based on the total weight of the metal alloy.

In some embodiments, the metal alloy comprises at least about 34 wt % of nickel (Ni) but not more than about 54 wt % of nickel (Ni), at least about 23 wt % cobalt (Co) and at least about 23 wt % of iron (Fe), based on the total weight of the metal alloy based on the total weight of the metal alloy. In some embodiments, the metal alloy comprises at least about 38 wt % of nickel (Ni) but not more than about 50 wt % of nickel (Ni), at least about 25 wt % cobalt (Co) and at least about 25 wt % of iron (Fe), based on the total weight of the metal alloy based on the total weight of the metal alloy. In some embodiments, the metal alloy comprises at least about 40 wt % of nickel (Ni) but not more than about 48 wt % of nickel (Ni), at least about 26 wt % cobalt (Co) and at least about 26 wt % of iron (Fe), based on the total weight of the metal alloy. In some embodiments, the metal alloy comprises at least about 42 wt % of nickel (Ni) but not more than about 48 wt % of nickel (Ni), at least about 26 wt % cobalt (Co) and at least about 26 wt % of iron (Fe). In some embodiments, the metal alloy comprises at least about 42 wt % of nickel (Ni) but not more than about 46 wt % of nickel (Ni), at least about 27 wt % cobalt (Co) and at least about 27 wt % of iron (Fe) based on the total weight of the metal alloy.

In some embodiments, in the metal alloy powder, the Ni is present in a greater wt % compared to the wt % of the Co or the Fe, based on the total weight of the metal alloy.

In some embodiments, the Ni, Co and Fe are present in the metal alloy in an weight percent ratio of about 1-2.4:1:1, about 1.2-2:1:1, about 1.3-1.8:1:1, about 1.4-1.7:1:1, about 1.4-1.6:1:1 or about 1.5-1.6:1:1. In some embodiments, the Ni, Co and Fe are present in the metal alloy in an wt percent ratio of about 1-2.4:1:1, about 1.2-2:1:1, about 1:3-1.8:1:1, about 1:4-1.6:1:1 or about 1.5-1.6:1:1. In some embodiments, the Ni, Co and Fe are present in the metal alloy in an weight percent ratio of about 1.3-1.8:1-1.2:1, about 1.3-1.7:1-1.2:1, or about 1.4-1.7:1-1.1:1.

In some embodiments, the application includes a metal alloy comprising
about 34 wt % to about 58 wt % of nickel (Ni);
about 21 wt % to about 33 wt % of cobalt (Co); and
about 21 wt % to about 33 wt % of iron (Fe), wherein all wt % are based on the total weight of the metal alloy.

In some embodiments, the metal alloy comprises about 34 (optionally, about 35, about 36, about 37, about 38, about 39, about 40, about 41, about 42, about 43, about 44, about 45, about 46, about 47, about 48, about 49, about 50, about 51, about 52, about 53, about 54, about 55, about 56, about 57) to about 58 wt % Ni, wherein all wt % are based on the total weight of the metal alloy. In some embodiments, the metal alloy comprises about 34 (optionally, about 35, about 36, about 37, about 38, about 39, about 40, about 41, about 42, about 43, about 44, about 45, about 46, about 47, about 48, about 49, about 50, about 51, about 52, about 53, about 54, about 55) to about 56 wt % Ni; about 34 (optionally, about 35, about 36, about 37, about 38, about 39, about 40, about 41, about 42, about 43, about 44, about 45, about 46, about 47, about 48, about 49, about 50, about 51, about 52, about 53) to about 54 wt % Ni; about 35 (optionally, about 36, about 37, about 38, about 39, about 40, about 41, about 42, about 43, about 44, about 45, about 46, about 47, about 48, about 49, about 50, about 51 or about 52) to about 53 wt % Ni; about 36 (optionally, about 37, about 38, about 39, about 40, about 41, about 42, about 43, about 44, about 45, about 46, about 47, about 48, about 49, about 50 or about 51) to about 52 wt % Ni; about 37 (optionally, about 38, about 39, about 40, about 41, about 42, about 43, about 44, about 45, about 46, about 47, about 48, about 49 or about 50) to about 51 wt % Ni; about 38 (optionally, about 39, about 40, about 41, about 42, about 43, about 44, about 45, about 46, about 47, about 48 or about 49) to about 50 wt % Ni; about 39 (optionally, about 40, about 41, about 42, about 43, about 44, about 45, about 46, about 47 or about 48) to about 49 wt % Ni; about 40 (optionally about 41, about 42, about 43, about 44, about 45, about 46 or about 47) to about 48 wt % Ni; about 41 (optionally, about 42, about 43, about 44, about 45 or about 46) to about 47 wt % Ni, about 42 (optionally, about 43, about 44, about 45) to about 46 wt % Ni; about 43 (optionally, about 44) to about 45 wt % of Ni, or about 42 (optionally about 43, about 44, about 45, about 46 or about 47) to about 48 wt % of Ni, wherein all wt % are based on the total weight of the metal alloy.

In some embodiments, the metal alloy comprises about 34 (optionally, about 35, about 36, about 37, about 38, about 39, about 40, about 41, about 42, about 43, about 44, about 45, about 46, about 47, about 48, about 49, about 50, about 51, about 52 or about 53) to about 54 wt % Ni; about 35 (optionally, about 36, about 37, about 38, about 39, about 40, about 41, about 42, about 43, about 44, about 45, about 46, about 47, about 48, about 49, about 50, about 51 or about 52) to about 53 wt % Ni; about 36 (optionally, about 37, about 38, about 39, about 40, about 41, about 42, about 43, about 44, about 45, about 46, about 47, about 48, about 49, about 50 or about 51) to about 52 wt % Ni; about 37 (optionally, about 38, about 39, about 40, about 41, about 42, about 43, about 44, about 45, about 46, about 47, about 48, about 49 or about 50) to about 51 wt % Ni; about 38 (optionally, about 39, about 40, about 41, about 42, about 43, about 44, about 45, about 46, about 47, about 48 or about 49) to about 50 wt % Ni; about 39 (optionally, about 40, about 41, about 42, about 43, about 44, about 45, about 46, about 47 or about 48) to about 49 wt % Ni; about 40 (optionally about 41, about 42, about 43, about 44, about 45, about 46 or about 47) to about 48 wt % Ni; about 41 (optionally, about 42, about 43, about 44, about 45 or about 46) to about 47 wt % Ni, about 42 (optionally, about 43, about 44, about 45) to about 46 wt %; about 43 (optionally, about 44) to about 45 wt % of Ni, wherein all wt % are based on the total weight of the metal alloy. In some embodiments, the metal alloy comprises about 38 (optionally, about 39, about 40, about 41, about 42, about 43, about 44, about 45, about 46, about 47, about 48 or about 49) to about 50 wt % Ni, about 40 (optionally about 41, about 42, about 43, about 44, about 45, about 46 or about 47) to about 48 wt % Ni; about 41 (optionally, about 42, about 43, about 44, about 45 or about 46) to about 47 wt % Ni, about 42 (optionally, about 43, about 44, about 45) to about 46 wt %; about 43 (optionally about 44) to about 45 wt % Ni, based on the total weight of the metal alloy, wherein all wt % are based on the total weight of the metal alloy. In some embodiments, the metal alloy comprises about 38 (optionally, about 39, about 40, about 41, about 42, about 43, about 44, about 45, about 46, about 47, about 48 or about 49) to about 50 wt % N, about 40 (optionally about 41, about 42, about 43, about 44, about 45, about 46 or about 47) to about 48 wt % Ni or about 42 (optionally, about 43, about 44, about 45) to about 46 wt % Ni; or about 43 (optionally about 44) to about 45 wt % Ni, wherein all wt % are based on the total weight of the metal alloy. In some embodiments, the metal alloy comprises about 40 (optionally about 41, about 42, about 43, about 44, about 45, about 46 or about 47) to about 48 wt % Ni; about 41 (optionally, about 42, about 43, about 44, about 45 or about 46) to about 47 wt % Ni, about 42 (optionally about 43, about 44, about 45, about 46 or about 47) to about 48 wt % of Ni; about 42 (optionally, about 43, about 44, about 45) to about 46 wt % Ni; about 43 (optionally, about 44, about 45 or about 46) to about 47 wt % of Ni; about 44 (optionally, about 44) to about 46 wt % of Ni, wherein all wt % are based on the total weight of the metal alloy.

In some embodiments, the metal alloy comprises about 34, about 35, about 36, about 37, about 38, about 39, about 40, about 41, about 42, about 43, about 44, about 45, about 46, about 47, about 48, about 49, about 50, about 51, about 52, about 53, about 54, about 55, about 56, about 57 or about 58 wt % Ni, wherein all wt % are based on the total weight of the metal alloy. In some embodiments, the metal alloy comprises about 34, about 35, about 36, about 37, about 38, about 39, about 40, about 41, about 42, about 43, about 44, about 45, about 46, about 47, about 48, about 49, about 50, about 51, about 52, about 53 or about 54 wt % Ni, wherein all wt % are based on the total weight of the metal alloy. In some embodiments, the metal alloy comprises about 38, about 40, about 42, about 44, about 46, about 48, or about 50 wt % Ni, wherein all wt % are based on the total weight of the metal alloy allo. In some embodiments, the metal alloy comprises about 40, about 42, about 44, about 46 or about 48 wt % Ni, wherein all wt % are based on the total weight of the metal alloy. In some embodiments, the metal alloy comprises about 42, about 44 or about 46 wt % Ni, wherein all wt % are based on the total weight of the metal alloy.

In some embodiments, the metal alloy comprises about 21 (optionally, about 22, about 23, about 24, about 25, about 26, about 27, about 28, about 29, about 30, about 31, about 32, about 33, about 34) to about 33 wt % Co; about 23 (optionally, about 24, about 25, about 26, about 27, about 28, about 29, about 30, about 31 or about 32) to about 33 wt % Co; about 24 (optionally, about 25, about 26, about 27, about 28, about 29, about 30, or about 31) to about 32 wt % Co; about 25 (optionally, about 26, about 27, about 28, about 29 or about 30) to about 31 wt % Co, about 26 (optionally, about 27, about 28 or about 29) to about 30 wt % Co; or about 27 (optionally, about 28) to about 29 wt % Co, wherein all wt % are based on the total weight of the metal alloy. In some embodiments, the metal alloy comprises about 24 (optionally, about 25, about 26, about 27, about 28, about 29, about 30, or about 31) to about 32 wt % Co; about 25 (optionally, about 26, about 27, about 28, about 29 or about 30) to about 31 wt % Co; about 26 (optionally, about 27, about 28 or about 29) to about 30 wt % Co; or about 27 (optionally, about 28) to about 29 wt % Co. In some embodiments, the metal alloy comprises about 25 (optionally, about 26, about 27, about 28, about 29 or about 30) to about 31 wt % Co; about 26 (optionally, about 27, about 28 or about 29) to about 30 wt % Co; or about 27 (optionally, about 28) to about 29 wt % Co, wherein all wt % are based on the total weight of the metal alloy. In some embodiments, the metal alloy comprises about 25 (optionally, about 26, about 27, about 28, about 29 or about 30) to about 31 wt % Co; about 25 (optionally, about 26, about 27, about 28, or about 29) to about 30 wt % Co; about 25 (optionally, about 26, about 27, or about 28) to about 29 wt % Co; about 25 (optionally, about 26 or about 27) to about 28 wt % Co; about 25 (optionally, about 26) to about 27 wt % Co; about 26 (optionally, about 27) to about 28 wt % Co; or about 26 (optionally, about 27 or about 28) to about 29 wt % Co, wherein all wt % are based on the total weight of the metal alloy.

In some embodiments, the metal alloy comprises about 21, about 22, about 23, about 24, about 25, about 26, about 27, about 28, about 29, about 30, about 31, about 32 or about 33 wt % Co based on the total weight of the metal alloy. In some embodiments, the metal alloy comprises about 23, about 24, about 25, about 26, about 27, about 28, about 29, about 30, about 31, about 32 or about 33 wt % Co. In some embodiments, the metal alloy comprises about 24, about 25, about 26, about 27, about 28, about 29, about 30, about 31 or about 32 wt % Co, wherein all wt % are based on the total weight of the metal alloy. In some embodiments, the metal alloy comprises about 25, about 26, about 27, about 28, about 29, about 30 or about 31 wt % Co, wherein all wt % are based on the total weight of the metal alloy. In some embodiments, the metal alloy comprises about 25, about 26, about 27, about 28, or about 29 wt % Co, wherein all wt % are based on the total weight of the metal alloy.

In some embodiments, the metal alloy comprises about 21 (optionally, about 22, about 23, about 24, about 25, about 26, about 27, about 28, about 29, about 30, about 31, about 32, about 33, about 34) to about 33 wt % Fe; about 23 (optionally, about 24, about 25, about 26, about 27, about 28, about 29, about 30, about 31 or about 32) to about 33 wt % Fe; about 24 (optionally, about 25, about 26, about 27, about 28, about 29, about 30, or about 31) to about 32 wt % Fe; about 25 (optionally, about 26, about 27, about 28, about 29 or about 30) to about 31 wt % Fe, about 26 (optionally, about 27, about 28 or about 29) to about 30 wt % Fe; or about 27 (optionally, about 28) to about 29 wt % Fe, wherein all wt % are based on the total weight of the metal alloy. In some embodiments, the metal alloy comprises about 24 (optionally, about 25, about 26, about 27, about 28, about 29, about 30, or about 31) to about 32 wt % Fe; about 25 (optionally, about 26, about 27, about 28, about 29 or about 30) to about 31 wt % Fe; about 26 (optionally, about 27, about 28 or about 29) to about 30 wt % Fe; or about 27 (optionally, about 28) to about 29 wt % Fe. In some embodiments, the metal alloy comprises about 25 (optionally, about 26, about 27, about 28, about 29 or about 30) to about 31 wt %; about 26 (optionally, about 27, about 28 or about 29) to about 30 wt % Fe; or about 27 (optionally, about 28) to about 29 wt % Fe, wherein all wt % are based on the total weight of the metal alloy. In some embodiments, the metal alloy comprises about 25 (optionally, about 26, about 27, about 28, about 29 or about 30) to about 31 wt % Fe; about 25 (optionally, about 26, about 27, about 28, or about 29) to about 30 wt % Fe; about 26 (optionally, about 27, about 28, about 29 or about 30) to about 31 wt % Fe; about 26 (optionally, about 27, about 28, or about 29) to about 30 wt % Fe; about 26 (optionally, about 27, about 28 or about 29) to about 29 wt % Fe, wherein all wt % are based on the total weight of the metal alloy.

In some embodiments, the metal alloy comprises about 21, about 22, about 23, about 24, about 25, about 26, about 27, about 28, about 29, about 30, about 31, about 32, about 33, about 34 or about 35 wt % Fe, wherein all wt % are based on the total weight of the metal alloy. In some embodiments, the metal alloy comprises about 23, about 24, about 25, about 26, about 27, about 28, about 29, about 30, about 31, about 32 or about 33 wt % Fe. In some embodiments, the metal alloy comprises about 24, about 25, about 26, about 27, about 28, about 29, about 30, about 31 or about 32 wt % Fe. In some embodiments, the metal alloy comprises about 25, about 26, about 27, about 28, about 29, about 30 or about 31 wt % Fe, wherein all wt % are based on the total weight of the metal alloy. In some embodiments, the metal alloy comprises about 25, about 26, about 27, about 28, about 29 about 30 or about 31 wt % Fe, wherein all wt % are based on the total weight of the metal alloy.

In some embodiments, the application includes a metal alloy comprising
about 34 wt % to about 54 wt % of nickel (Ni);
about 23 wt % to about 33 wt % of cobalt (Co); and
about 23 wt % to about 33 wt % of iron (Fe), wherein all wt % are based on the total weight of the metal alloy.

In some embodiments, the application includes a metal alloy comprising
about 38 wt % to about 50 wt % of nickel (Ni);
about 25 wt % to about 31 wt % of cobalt (Co); and
about 25 wt % to about 31 wt % of iron (Fe), wherein all wt % are based on the total weight of the metal alloy.

In some embodiments, the application includes a metal alloy comprising
about 40 weight (wt) % to about 48 wt % of nickel (Ni);
about 26 wt % to about 30 wt % of cobalt (Co); and
about 26 wt % to about 30 wt % of iron (Fe), all wt % based on the total weight of the metal alloy).

In some embodiments, the application includes a metal alloy comprising
about 40 wt % to about 48 wt % of nickel (Ni);
about 25 wt % to about 30 wt % of cobalt (Co); and
about 25 wt % to about 30 wt % of iron (Fe), all wt % based on the total weight of the metal alloy.

In some embodiments, the application includes a metal alloy comprising
about 42 wt % to about 48 wt % of nickel (Ni);
about 25 wt % to about 29 wt % of cobalt (Co); and
about 25 wt % to about 29 wt % of iron (Fe), all wt % based on the total weight of the metal alloy.

In some embodiments, the application includes a metal alloy comprising
about 42 wt % to about 46 wt % of nickel (Ni);
about 27 wt % to about 29 wt % of cobalt (Co); and
about 27 to about 29 wt % of iron (Fe), all wt % based on the total weight of the metal alloy.

In some embodiments, the application includes a metal alloy comprising
about 44 wt % to about 48 wt % of nickel (Ni);
about 25 wt % to about 28 wt % of cobalt (Co); and
about 25 wt % to about 28 wt % of iron (Fe), all wt % are based on the total weight of the metal alloy.

In some embodiments, the application includes a metal alloy comprising
about 44 wt % to about 46 wt % of nickel (Ni);
about 26 wt % to about 28 wt % of cobalt (Co); and
about 26 wt % to about 28 wt % of iron (Fe), all wt % are based on the total weight of the metal alloy.

In some embodiments, the application includes a metal alloy comprising
about 43 wt % to about 45 wt % of nickel (Ni);
about 28 wt % to about 29 wt % of cobalt (Co); and
about 27 wt % to about 28 wt % of iron (Fe), all wt % are based on the total weight of the metal alloy.

In some embodiments, the application includes a metal alloy comprising
about 44 wt % of nickel (Ni);
about 28 wt % of cobalt (Co); and
about 28 wt % of iron (Fe), all wt % are based on the total weight of the metal alloy.

In some embodiments, the application includes a metal alloy comprising
about 46 wt % of nickel (Ni);
about 26 wt % of cobalt (Co); and
about 28 wt % of iron (Fe), all wt % are based on the total weight of the metal alloy.

In some embodiments, the metal alloy is for use as a metal alloy for forming metal matrix composite. In some embodiments, the metal alloy is for use as a metal alloy for forming metal matrix composite using laser powder bed fusion (LPBF) additive manufacturing. Therefore, in some embodiments, the metal alloy is for use in laser powder bed fusion (LPBF) additive manufacturing. In some embodiments, the laser powder bed fusion is selected from selective laser sintering (SLS), selective laser melting (SLM) and direct metal laser sintering (DMLS).

In some embodiments, the metal alloy is prepared from a mixture of elemental Ni, Co and Fe. Therefore, in some embodiments, the application further includes a metal mixture comprising Ni, Co and Fe wherein the Ni, Co and Fe are present in the metal mixture in an atomic % and/or wt % that is the same as the atomic % and/or wt % for Ni, Co and Fe in the metal alloy described above including embodiments thereof.

In some embodiments, the metal mixture is for use as a metal alloy mixture for forming metal matrix composites. In some embodiments, the metal mixture is for use as a binder mixture for forming metal matrix composite using laser powder bed fusion (LPBF) additive manufacturing. Therefore, in some embodiments, the metal mixture is for use in laser powder bed fusion (LPBF) additive manufacturing.

In some embodiments, the metal alloy comprises relatively large proportions of the Ni, Co and Fe. Therefore, in some embodiments, the metal alloy is a multi-principal element alloy (MPEA).

In some embodiments, the metal alloy is prepared by any suitable method of alloying known in the art. In some embodiments, the metal alloy is prepared by casting or sintering such as vacuum sintering. In some embodiments, the metal alloy is prepared by casting. Therefore, in some embodiments, the metal alloy is a casted metal alloy. In some embodiments, the metal alloy is a cast strip or cast rod.

The metal alloy of the application was observed to be single phase (e.g. only one shade of grey was observed). Calculated thermodynamic phase diagrams using Calculation of Phase Diagrams (CALPHAD) have also indicated that the metal alloy advantageously comprise a homogeneous single phase of structure and that the single phase of structure is a face centered cubic microstructure. The metal alloy of the application was also observed to be single phase using scanning electron micrographs.

In some embodiments, the metal alloy comprises a single phase (homogeneous) of structure. In some embodiments, the metal alloy formed after casting comprises substantially a single phase of structure. In some embodiments, the metal alloy comprises substantially a face centered cubic (fcc) field of structure.

In some embodiments, the metal alloy is stable against phase separation and phase changes.

In some embodiments, the metal alloy is further heat treated to provide a heat-treated metal alloy. In some embodiments, the metal alloy is heat treated at a temperature of about 1500° C. to about 1600° C., about 1525° C. to about 1575° C. or about 1550° C. In some embodiments, the metal alloy is heat treated at a temperature of about 1550° C.

In some embodiments, the metal alloy is heat treated using any method of heat treatment known in the art. In some embodiments, the heat treating is plasma heat treating

In some embodiments, the metal alloy is heat treated for about 30 minutes to about 120 minutes, about 30 minutes to about 90 hours, about 45 minutes to about 75 minutes, or about 45 minutes, 60 minutes, or about 75 minutes. In some embodiments, the metal alloy is heat treated for about 60 minutes.

In some embodiments, the structure of the metal alloy before heat treatment and after heat treatment appears substantially the same (e.g. is face centered cubic (fcc)).

In some embodiments, the metal alloy of the application comprises about 20% or less, about 15% or less, about 10% or less, about 5% or less, about 4% or less, about 3% or less, about 2% or less, or about 1% or less of any other phases other than fcc as measured, for example, by scanning electron micrographs, energy dispersive X-ray fluorescence (EDXRF), X-ray diffraction (XRD) and/or transmission electron microscopy (TEM). In some embodiments, the metal alloy of the application comprises about 5% or less, about 4% or less, about 3% or less, about 2% or less, or about 1% or less of any other phases other than fcc as measured, for example, by scanning electron micrographs, energy dispersive X-ray fluorescence (EDXRF), X-ray diffraction (XRD) and/or transmission electron microscopy (TEM

In some embodiments, the metal alloy is formed into a powder. Therefore, in some embodiments, the metal alloy is a metal alloy powder.

In some embodiments, the metal alloy powder is prepared using any suitable methods of preparing a powder from an alloy known in the art. In some embodiments, the powder is prepared by atomization (i.e., spray granulation), milling such as ball milling and attribitor milling, cryomilling, laser ablation, electron-discharge machining, wire explosion, electrode induction melting or spheriodization. In some embodiments, powder is prepared by atomization.

In some embodiments, the atomization is gas atomization, ultrasonic atomization or plasma atomization. In some embodiments, the gas atomization is commercial gas atomization. In some embodiments, the atomization is ultrasonic atomization. In an exemplary embodiment, the metal alloy is atomized (optionally ultrasonically atomized or gas atomized) to provide a metal alloy powder suitable for use in laser powder bed fusion. Therefore, in some embodiments, the metal powder is a atomized (optionally gas atomized metal alloy power or ultrasonically atomized metal alloy powder), and the present application comprises an atomized (optionally gas atomized metal alloy power or ultrasonically atomized metal alloy powder comprising Ni, Co, and Fe as described above including embodiments thereof.

In some embodiments, the metal alloy powder comprises individual spherical particles of the metal alloy. Therefore, in some embodiments, the metal alloy powder is a spherical metal alloy powder.

In some embodiments, the metal alloy has an alloy purity of at least about 95 wt %, at least about 96 wt %, at least about 97 wt %, at least about 98 wt %, at least about 99 wt %, at least about 99.1 wt %, at least about 99.2 wt %, at least about 99.3 wt %, at least about 99.4 wt %, at least about 99.5 wt %, at least about 99.6 wt %, at least about 99.7 wt %, at least about 99.8 wt %, or at least about 99.9 wt % based on the total weight of the metal alloy. In some embodiments, the metal alloy has an alloy purity at least 98 wt %, at least 99 wt %, at least 99.1 wt %, at least 99.2 wt %, at least 99.3 wt %, at least 99.4 wt %, or at least 99.5 wt %, wherein all wt % are based on the total weight of the metal alloy.

In some embodiments, the metal alloy (optionally casted metal alloy, or heat treated metal alloy) or metal alloy powder further comprises one or more impurities. In some embodiments, the metal alloy (optionally casted metal alloy, or heat treated metal alloy) or metal alloy powder comprises less than about 1.5 wt %, about 1.2 wt %, about 1 wt %, about 0.9 wt %, about 0.8 wt %, about 0.7 wt %, about 0.6 wt %, about 0.5 wt %, about 0.4 wt %, about 0.35 wt %, about 0.3 wt %, about 0.25 wt %, about 0.2 wt %, about 0.15 wt % or about 0.1 wt % of impurities based on the total weight of the metal alloy. In some embodiments, the metal alloy (optionally casted metal alloy, or heat treated metal alloy) or metal alloy powder comprises less than about 0.6 wt %, about 0.5 wt %, about 0.4 wt %, about 0.35 wt %, about 0.3 wt %, about 0.25 wt % or about 0.2 wt % of impurities based on the total weight of the metal alloy.

In some embodiments, the one or more impurities are selected from silicon (Si), chromium (Cr), carbon (C), and manganese (Mn) and mixtures thereof. In some embodiments, the one or more impurities are selected from silicon (Si) and chromium (Cr) and mixtures thereof.

In some embodiments, the metal alloy (optionally casted metal alloy, or heat treated metal alloy) or metal alloy powder comprises less than about 0.4 wt %, about 0.35 wt %, about 0.3 wt %, about 0.25 wt %, about 0.2 wt % or about 0.15 wt % of Si based on the total weight of the metal alloy. In some embodiments, the metal alloy (optionally casted metal alloy, or heat treated metal alloy) or metal alloy powder comprises less than about 0.4 wt %, about 0.35 wt %, about 0.3 wt %, about 0.25 wt %, about 0.2 wt %, about 0.15 wt %, about 0.1 wt %, about 0.05 wt %, about 0.02 wt %, or about 0.01 wt % of Si based on the total weight of the metal alloy

In some embodiments, the metal alloy (optionally casted metal alloy, or heat treated metal alloy) or metal alloy powder comprises less than about 0.5 wt %, about 0.4 wt %, about 0.35 wt %, about 0.3 wt %, about 0.25 wt % or about 0.2 wt % of Cr based on the total weight of the metal alloy.

In some embodiments, the metal alloy (optionally casted metal alloy, or heat treated metal alloy) or metal alloy powder comprises less than about 0.25 wt %, about 0.2 wt %, about 0.15 wt % or about 0.1 wt % of Mn based on the total weight of the metal alloy.

In some embodiments, the metal alloy (optionally casted metal alloy, or heat treated metal alloy) or metal alloy powder comprises less than about 0.2 wt %, about 0.15 wt %, about 0.1 wt %, about 0.05 wt %, about 0.02 wt %, or about 0.01 wt % of C based on the total weight of the metal alloy.

In some embodiments, the purity of the metal alloy is characterized using any suitable methods of characterizing the structure of an alloy known in the art. In some embodiments, the microstructure of the alloy is characterized using optical microscopy, transmission electron microscopy or scanning electron microscopy, x-ray fluorescence, Inductively Coupled Plasma Atomic Emission Spectroscopy (ICP-AES) or ICP Atomic Emission Spectroscopy, or Inductively Coupled Plasma Mass Spectrometry (ICP-MS) or ICP Mass Spectrometry or Glow Discharge Mass Spectrometry (GDMS), Spark Source Mass Spec (SSMS) Analysis, EDX, or any combinations thereof.

In some embodiments, the composition of the metal alloy is determined using any suitable means of determining the composition of the metal alloy known in the art. In some embodiments, the composition of the metal alloy is determined using X-ray diffraction (XRD) and energy dispersive X-ray spectroscopy (EDS), x-ray fluorescence, Inductively Coupled Plasma Atomic Emission Spectroscopy (ICP-AES) or ICP Atomic Emission Spectroscopy Inductively Coupled Plasma Mass Spectrometry (ICP-MS), ICP Mass Spectrometry or Glow Discharge Mass Spectrometry (GDMS), Spark Source Mass Spec (SSMS) Analysis, EDX, or combinations thereof.

A person skilled in the art would appreciate that a metal alloy powder suitable for use in laser powder bed should comprises a flow rate and particle size distribution suitable for use in laser powder bed fusion. A metal alloy powder comprising too low of an particle size distribution would have reduced fluidity, while metal alloy powder comprising too high of a particle size distribution may provide a layer of non-uniform thickness in the powder bed for laser powder bed fusion.

In some embodiments, the metal alloy powder comprises a mean particle size of about 40 μm to about 150 μm, about 40 μm to about 125 μm, about 40 μm to about 100 μm, about 40 μm to about 60 μm, about 40 μm to about 50 μm, about 45 μm to about 60 μm, about 45 μm to about 55 μm, about 45 μm to about 50 μm. In some embodiments, the metal alloy powder comprises a mean particle size of, about 45 μm to about 55 μm or about 45 μm to about 50 μm.

In some embodiments, the metal alloy powder comprises an mean particle size of about 40 μm, about 45 μm, about 50 μm or about 55 μm.

In some embodiments, the metal alloy powder comprises a D₁₀ of about 20 μm to about 35 μm, about 20 μm to about 30 μm, about 20 μm to about 25 μm, about 25 μm to about 35 μm or about 25 μm to about 30 μm. In some embodiments, the metal alloy powder comprises a D₁₀ of about 20 μm to about 30 μm.

In some embodiments, the metal alloy powder comprises a D₁₀ of about 20 μm, about 25 μm, about 30 μm or about 35 μm. In some embodiments, the metal alloy powder comprises a D₁₀ of about 20 μm, about 25 μm or about 30 μm.

In some embodiments, the metal alloy powder comprises a D₅₀ of about 35 μm to about 55 μm, about 35 μm to about 50 μm, about 35 μm to about 45 μm, about 40 μm to about 55 μm, about 40 μm to about 50 μm or about 40 μm to about 45 μm. In some embodiments, the metal alloy powder comprises a D₅₀ of about 40 μm to about 50 μm or about 40 μm to about 45 μm. In some embodiments, the metal alloy powder comprises a D₅₀ of about 40 μm to about 45 μm. In some embodiments, the metal alloy powder comprises a D₅₀ of about 30 μm to about 50 μm, about 30 μm to about 45 μm, or about 35 μm to about 45 μm. In some embodiments, the metal alloy powder comprises a D₅₀ of about 35 μm to about 45 μm.

In some embodiments, the metal alloy powder comprises a D₅₀ of about 35 μm, about 40 μm, about 45 μm, about 50 μm or about 55 μm. In some embodiments, the metal alloy powder comprises a D₅₀ of about 40 μm, about 45 μm or about 50 μm. In some embodiments, the metal alloy powder comprises a D₅₀ of about 35 μm, about 40 μm or about 45 μm.

In some embodiments, the metal alloy powder comprises a D₉₀ of about 60 μm to about 80 μm, about 60 μm to about 75 μm, about 65 μm to about 80 μm, about 65 μm to about 75 μm, about 65 μm to about 80 μm, about 65 μm to about 75 μm, about 70 μm to about 80 μm or about 70 μm to about 75 μm. In some embodiments, the metal alloy powder comprises a D₉₀ of about 65 μm to about 75 μm, about 70 μm to about 80 μm or about 70 μm to about 75 μm. In some embodiments, the metal alloy powder comprises a D₉₀ of about 70 μm to about 75 μm. In some embodiments, the metal alloy powder comprises a D₉₀ of about 45 μm to about 75 μm, about 45 μm to about 70 μm, about 45 μm to about 65 μm, about 45 μm to about 60 μm, about 50 μm to about 75 μm, about 50 μm to about 70 μm, about 50 μm to about 65 μm, about 50 μm to about 60 μm, about 55 μm to 75 μm or about 60 μm to 75 μm. In some embodiments, the metal alloy powder comprises a D₉₀ of about 45 μm to about 75 μm, about 45 μm to about 65 μm, about 50 μm to about 75 μm, or about 50 μm to about 75 μm.

In some embodiments, the particle size is measured using any suitable method of measuring particle size known in the art. In some embodiments, the particle size is measured using laser light scattering, laser diffraction, dynamic light scattering, or dynamic image analysis techniques.

In some embodiments, the metal alloy powder comprises a Hall flow rate of about 30 seconds or less, about 25 seconds or less, about 20 seconds or less, about 19 seconds or less, about 18 seconds or less, about 17 seconds or less, about 16 seconds or less, about 15 seconds or less, about 14 seconds or less, about 13 seconds or less, about 12 seconds or less, about 11 seconds or less, about 10 seconds or less, about 9 seconds or less, about 8 seconds or less, about 7 seconds or less, about 6 seconds or less or about 5 seconds or less (based on 50 g of the metal alloy powder composition). In some embodiments, metal alloy powder comprises a Hall flow rate of about 18 seconds or less, about 17 seconds or less, about 16 seconds or less, about 15 seconds or less, about 14 seconds or less or about 13 seconds or less (based on 50 g of the metal alloy powder composition). In some embodiments, metal alloy powder comprises a Hall flow rate of about 16 seconds or less, about 15 seconds or less, about 14 seconds or less, about 13 seconds or less or about 12 seconds or less (based on 50 g of the metal alloy powder composition).

In some embodiments, metal alloy powder comprises an apparent density of about 3 to about 6 g/cc (grams per cubic centimeter), about 3.5 to about 6 g/cc, about 3.5 to about 5.5 g/cc, about 3.5 to about 5 g/cc, about 4 to about 6 g/cc, about 4 to about 5.5 g/cc, about 4 to about 5 g/cc, about 4.5 to about 6 g/cc, about 4.5 to about 5.5 g/cc, or about 4.5 to about 5 g/cc. In some embodiments, metal alloy powder comprises an apparent density of about 3.5 to about 5.5 g/cc, about 4 to about 5.5 g/cc, about 4 to about 5 g/cc, or about 4.5 to about 5 g/cc.

The metal alloy has also been shown to be useful as a feedstock on its own (i.e., without a hard component) for LPBF additive manufacturing to form a LPBF additively manufactured product. Therefore, the present application further includes a laser powder bed fusion (LPBF) additively manufactured product prepared from the metal alloy powder of the application. In some embodiments, the additively manufactured product prepared from the metal alloy powder of the application may be substantially free of cracks.

As used herein, “substantially free of cracks” in respect to the additively manufactured product prepared from the metal alloy powder of the application means that at least 99 vol % of the metal alloy contains no linear or tortuous cracks that are greater than 0.1 μm in width or greater than 10 μm in length.

In some embodiments, at least 99, at least 99.1, at least 99.2, at least 99.3, at least 99.4, at least 99.5, at least 99.6, at least 99.7, at least 99.8, at least 99.9 vol % the metal alloy contains no linear or tortuous cracks that are greater than 0.1 μm in width or greater than 10 μm in length.

Hard component portion-metal alloy powder blend

It has also been shown that the metal alloy powder of the application can be blended with a hard component portion comprising the hard component such as a carbide (e.g. tungsten carbide) only, or a hard component that has been processed (e.g. spray dried) in combination with an elemental metal such as Ni to provide a hard component portion-metal alloy powder blend suitable for use to prepare a metal-matrix composite. The hard component portion-metal alloy powder blend can be used to form a MMC using conventional methods known in the art for providing MMCs or for example, by laser powder bed fusion additive manufacturing.

Therefore, the application also includes a hard component portion-metal alloy powder blend comprising at least about 5 wt % of the metal alloy powder of the application wherein the wt % is based on total weight of the hard component portion-metal alloy powder blend. In some embodiments, the application also includes a hard component portion-metal alloy powder blend comprising at least about 0.5 wt % to about 95 wt % of a hard component portion and at least about 5 wt % of the metal alloy powder of the application wherein the wt % is based on total weight of the hard component portion-metal alloy powder blend.

In some embodiments, the hard component portion is a hard component alone, or a hard component in combination with the metal alloy of the application, or one or more elemental metals selected from Ni, Co and Fe, or mixtures thereof.

In some embodiments, the hard component of the hard component portion is selected from diamond, and metal or metalloid carbides, borides, nitrides and carbonitrides and mixtures thereof, wherein the metal or metalloid is selected from tungsten, titanium, zirconium, hafnium, vanadium, niobium, tantalum, chromium, silicon and molybdenum.

In some embodiments, the hard component is selected from diamond; carbides selected from, but not limited to, tungsten carbide, chromium carbide, hafnium carbide, vanadium carbide, niobium carbide, molybdenum carbide, tantalum carbide, titanium carbide, zirconium carbide, hafnium carbide, silicon carbide and boron carbide and mixtures thereof; borides selected from, but not limited to, molybdenum boride, chromium boride, hafnium boride, zirconium boride, tantalum boride and titanium boride and mixtures thereof; and nitrides selected from, but not limited to, boron nitride, titanium nitride, silicon nitride and aluminium nitride and mixtures thereof; and mixtures thereof.

In some embodiments, the hard component is selected from diamond, and metal or metalloid carbides, borides and nitrides, and mixtures thereof wherein the metal or metalloid is selected from tungsten, titanium, zirconium, hafnium, vanadium, niobium, tantalum, chromium, silicon and molybdenum. In some embodiments, the hard component is selected from diamond and metal or metalloid carbides wherein the metal or metalloid is selected from tungsten, titanium, zirconium, hafnium, vanadium, niobium, tantalum, chromium, silicon and molybdenum. In some embodiments, the hard component is selected from diamond, tungsten carbide, chromium carbide, hafnium carbide, vanadium carbide, niobium carbide, molybdenum carbide, tantalum carbide, titanium carbide, zirconium carbide, hafnium carbide, silicon carbide and boron carbide and mixtures thereof. In some embodiments, the hard component is selected from diamond and tungsten carbide, and mixtures thereof. In some embodiments, the hard component is tungsten carbide.

Therefore, in an exemplary embodiment, the hard component portion-metal alloy powder blend is a tungsten carbide portion-metal alloy powder blend.

In some embodiments, the present application includes a tungsten carbide portion-metal alloy powder blend comprising at least about 0.5 wt % to about 95 wt % of tungsten carbide portion and at least about 5 wt % of the metal alloy of the application wherein the wt % is based on total weight of the tungsten carbide portion-metal alloy powder blend.

In some embodiments, the metal alloy powder of the application is as described above under “metal alloy of the application” including embodiments thereof.

In some embodiments, the hard component (optionally, tungsten carbide) portion-metal alloy powder blend comprises at least about 0.5 wt %, about 1 wt %, about 3 wt %, about 5 wt %, about 7 wt %, about 8 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 91 wt %, about 92 wt %, about 93 wt %, about 94 wt % or about 95 wt % of hard component (optionally, tungsten carbide) portion based on total weight of the hard component (optionally, tungsten carbide) portion-metal alloy powder blend. In some embodiments, the hard component (optionally, tungsten carbide) portion-metal alloy powder blend comprises at least about 0.5 wt %, about 1 wt %, about 3 wt %, about 5 wt %, about 7 wt %, about 8 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, or about 80 wt % of hard component (optionally, tungsten carbide) portion based on total weight of the hard component (optionally tungsten carbide)-metal alloy powder blend. In some embodiments, the hard component (optionally tungsten carbide) portion-metal alloy powder blend comprises at least about 10 wt %, about 15 wt %, about 20 wt %, about 25 wt %, about 30 wt %, about 35 wt %, about 40 wt %, about 45 wt % or about 50 wt % of the hard component (optionally, tungsten carbide) portion based on total weight of the hard component (optionally, tungsten carbide) portion-metal alloy powder blend. In some embodiments, the hard component (optionally, tungsten carbide) portion-metal alloy powder blend comprises at least about 60 wt %, about 65 wt %, about 70 wt %, about 75 wt %, about 80 wt %, or about 85% or about 90% of hard component (optionally, tungsten carbide) portion based on total weight of the hard component (optionally tungsten carbide) portion-metal alloy powder blend.

In some embodiments, the present application includes a hard component (optionally, tungsten carbide) portion-metal alloy powder blend comprising
about 0.5 wt % to about 95 wt % of a hard component (optionally, tungsten carbide) portion; and
about 5 wt % to about 99.5 wt % of the metal alloy of the application based on total weight of the hard component (optionally tungsten carbide) portion-metal alloy powder blend.

In some embodiments, the a hard component (optionally, tungsten carbide) portion-metal alloy powder blend comprises about 1 wt % to about 95 wt %, about 5 wt % to about 95 wt %, about 10 wt % to about 95 wt %, about 10 wt % to about 90 wt %, about 20 wt % to about 90 wt %, about 30 wt % to about 90 wt %, about 40 wt % to about 90 wt %, about 50 wt % to about 90 wt %, about 60 wt % to about 90 wt %, about 70 wt % to about 90 wt %, about 75 wt % to about 90 wt %, about 80 wt % to about 90 wt %, about 85 wt % to about 90 wt %, about 10 wt % to about 85 wt %, about 20 wt % to about 85 wt %, about 30 wt % to about 85 wt %, about 40 wt % to about 85 wt %, about 50 wt % to about 85 wt %, about 60 wt % to about 85 wt %, about 65 wt % to about 85 wt %, about 70 wt % to about 85 wt %, about 80 wt % to about 85 wt %, about 10 wt % to about 80 wt %, about 20 wt % to about 80 wt %, about 30 wt % to about 80 wt %, about 40 wt % to about 80 wt %, about 50 wt % to about 80 wt %, about 60 wt % to about 80 wt %, about 65 wt % to about 80 wt %, about 70 wt % to about 80 wt %, about 75 wt % to about 80 wt %, about 10 wt % to about 75 wt %, about 20 wt % to about 75 wt %, about 30 wt % to about 75 wt %, about 40 wt % to about 75 wt %, about 50 wt % to about 75 wt %, about 60 wt % to about 75 wt %, about 65 wt % to about 75 wt %, or about 70 wt % to about 75 wt % of hard component (optionally, tungsten carbide) portion based on total weight of the hard component (optionally, tungsten carbide) portion-metal alloy powder blend.

In some embodiments, the a hard component (optionally, tungsten carbide) portion-metal alloy powder blend comprises about 0.5 wt % to about 80 wt %, about 1 wt % to about 80 wt %, about 5 wt % to about 80 wt %, about 10 wt % to about 80 wt %, about 20 wt % to about 80 wt %, about 30 wt % to about 80 wt %, about 40 wt % to about 80 wt %, about 50 wt % to about 80 wt %, about 60 wt % to about 80 wt %, about 65 wt % to about 80 wt %, about 70 wt % to about 80 wt %, about 75 wt % to about 80 wt %, about 10 wt % to about 75 wt %, about 20 wt % to about 75 wt %, about 30 wt % to about 75 wt %, about 40 wt % to about 75 wt %, about 50 wt % to about 75 wt %, about 60 wt % to about 75 wt %, about 65 wt % to about 75 wt %, or about 70 wt % to about 75 wt %, about 0.5 wt % to about 75 wt %, about 1 wt % to about 75 wt %, about 5 wt % to about 75 wt %, about 10 wt % to about 75 wt %, about 20 wt % to about 75 wt %, about 30 wt % to about 75 wt %, about 40 wt % to about 75 wt %, about 50 wt % to about 75 wt %, about 60 wt % to about 75 wt %, about 65 wt % to about 75 wt %, about 0.5 wt % to about 70 wt %, about 1 wt % to about 70 wt %, about 5 wt % to about 70 wt %, about 10 wt % to about 70 wt %, about 20 wt % to about 70 wt %, about 30 wt % to about 70 wt %, about 40 wt % to about 70 wt %, about 50 wt % to about 70 wt %, about 60 wt % to about 70 wt %, about 65 wt % to about 70 wt %, about 0.5 wt % to about 65 wt %, about 1 wt % to about 65 wt %, about 5 wt % to about 65 wt %, about 10 wt % to about 65 wt %, about 20 wt % to about 65 wt %, about 30 wt % to about 65 wt %, about 40 wt % to about 65 wt %, about 50 wt % to about 65 wt %, about 60 wt % to about 65 wt %, about 0.5 wt % to about 60 wt %, about 1 wt % to about 60 wt %, about 5 wt % to about 60 wt %, about 10 wt % to about 60 wt %, about 20 wt % to about 60 wt %, about 30 wt % to about 60 wt %, about 40 wt % to about 60 wt %, about 50 wt % to about 60 wt %, about 0.5 wt % to about 55 wt %, about 1 wt % to about 55 wt %, about 5 wt % to about 55 wt %, about 10 wt % to about 55 wt %, about 20 wt % to about 55 wt %, about 30 wt % to about 55 wt %, about 40 wt % to about 55 wt %, about 45 wt % to about 55 wt %, about 0.5 wt % to about 50 wt %, about 1 wt % to about 50 wt %, about 5 wt % to about 50 wt %, about 10 wt % to about 50 wt %, about 20 wt % to about 50 wt %, about 30 wt % to about 50 wt %, about 40 wt % to about 50 wt %, about 45 wt % to about 50 wt %, about 0.5 wt % to about 45 wt %, about 1 wt % to about 45 wt %, about 5 wt % to about 45 wt %, about 10 wt % to about 45 wt %, about 20 wt % to about 45 wt %, about 30 wt % to about 45 wt %, about 40 wt % to about 45 wt %, about 0.5 wt % to about 40 wt %, about 1 wt % to about 40 wt %, about 5 wt % to about 40 wt %, about 10 wt % to about 40 wt %, about 20 wt % to about 40 wt %, about 30 wt % to about 40 wt %, about 0.5 wt % to about 35 wt %, about 1 wt % to about 35 wt %, about 5 wt % to about 35 wt %, about 10 wt % to about 35 wt %, about 20 wt % to about 35 wt %, about 30 wt % to about 35 wt %, of hard component (optionally, tungsten carbide) portion based on total weight of the hard component (optionally tungsten carbide) portion-metal alloy powder blend. In some embodiments, the a hard component (optionally, tungsten carbide) portion-metal alloy powder blend comprises about 0.5 wt % to about 75 wt %, about 1 wt % to about 75 wt %, about 5 wt % to about 75 wt %, about 10 wt % to about 75 wt %, about 20 wt % to about 75 wt %, about 30 wt % to about 75 wt %, about 40 wt % to about 75 wt %, about 50 wt % to about 75 wt %, about 60 wt % to about 75 wt %, about 65 wt % to about 75 wt %, about 0.5 wt % to about 70 wt %, about 1 wt % to about 70 wt %, about 5 wt % to about 70 wt %, about 10 wt % to about 70 wt %, about 20 wt % to about 70 wt %, about 30 wt % to about 70 wt %, about 40 wt % to about 70 wt %, about 50 wt % to about 70 wt %, about 60 wt % to about 70 wt %, about 65 wt % to about 70 wt %, about 0.5 wt % to about 65 wt %, about 1 wt % to about 65 wt %, about 5 wt % to about 65 wt %, about 10 wt % to about 65 wt %, about 20 wt % to about 65 wt %, about 30 wt % to about 65 wt %, about 40 wt % to about 65 wt %, about 50 wt % to about 65 wt %, about 60 wt % to about 65 wt % of hard component (optionally, tungsten carbide) portion based on total weight of the hard component (optionally tungsten carbide) portion-metal alloy powder blend.

In some embodiments, the hard component (optionally, tungsten carbide) portion-metal alloy powder blend comprises about 50 wt % to about 90 wt %, about 60 wt % to about 90 wt %, about 70 wt % to about 90 wt %, about 75 wt % to about 90 wt %, about 80 wt % to about 90 wt %, about 85 wt % to about 90 wt %, about 50 wt % to about 85 wt %, about 60 wt % to about 85 wt %, about 65 wt % to about 85 wt %, about 70 wt % to about 85 wt %, about 80 wt % to about 85 wt %, about 50 wt % to about 80 wt %, about 60 wt % to about 80 wt %, about 65 wt % to about 80 wt %, about 70 wt % to about 80 wt %, about 75 wt % to about 80 wt %, about 50 wt % to about 75 wt %, about 60 wt % to about 75 wt %, about 65 wt % to about 75 wt %, or about 70 wt % to about 75 wt % of hard component (optionally, tungsten carbide) portion based on total weight of the hard component (optionally, tungsten carbide)-portion metal alloy powder blend. In some embodiments, the hard component (optionally, tungsten carbide) portion-metal alloy powder blend comprises about 60 wt % to about 90 wt %, about 70 wt % to about 90 wt %, about 60 wt % to about 85 wt % or about 65 wt % to about 85 wt % of hard component (optionally tungsten carbide) portion based on total weight of the hard component (optionally tungsten carbide) portion-metal alloy powder blend.

In some embodiments, the hard component (optionally, tungsten carbide) portion is the hard component (optionally tungsten carbide) alone. Accordingly, in the embodiments above, the hard component (optionally, tungsten carbide) portion-metal alloy powder blend is a hard component (optionally, tungsten carbide)-metal alloy powder blend.

In some embodiments, the hard component (optionally, tungsten carbide) portion-metal alloy powder blends of the application are for use to form to MMCs. The MMCs may be formed by conventional processes or by additive manufacturing processes. MMCs formed using conventional methods known in the art are not subject to the limitations of additive manufacturing described above and therefore may comprise higher amounts of the hard component (optionally tungsten carbide) portion compared to MMCs formed using additive manufacturing techniques. As described above, the hard component (optionally tungsten carbide powder) may be subjected to additional processing techniques known in the art to improve flow characteristics and thereby increase the amounts of the hard component (optionally tungsten carbide) that can be used in the hard component (optionally, tungsten carbide) portion-metal alloy powder blends for use in additive manufacturing.

In some embodiments, the hard component (optionally, tungsten carbide) portion-metal alloy powder blends of the application are for use to form MMC using conventional processes. It would be appreciated that MMCs prepared using conventional processes may comprises high amount of hard component. Therefore, in some embodiments, hard component (optionally tungsten carbide)-metal alloy powder blend comprises
about 50 wt % to about 95 wt % of hard component (optionally tungsten carbide) portion; and
about 5 wt % to about 50 wt % of the metal alloy of the application based on total weight of the hard component (optionally tungsten carbide)-metal alloy powder blend.

In some embodiments, the hard component (optionally, tungsten carbide) portion-metal alloy powder blend comprises about 50 wt % to about 90 wt %, about 60 wt % to about 90 wt %, about 70 wt % to about 90 wt %, about 75 wt % to about 90 wt %, about 80 wt % to about 90 wt %, about 85 wt % to about 90 wt %, about 50 wt % to about 85 wt %, about 60 wt % to about 85 wt %, about 65 wt % to about 85 wt %, about 70 wt % to about 85 wt %, about 80 wt % to about 85 wt %, about 50 wt % to about 80 wt %, about 60 wt % to about 80 wt %, about 65 wt % to about 80 wt %, about 70 wt % to about 80 wt %, about 75 wt % to about 80 wt %, about 50 wt % to about 75 wt %, about 60 wt % to about 75 wt %, about 65 wt % to about 75 wt %, or about 70 wt % to about 75 wt % of hard component (optionally, tungsten carbide) portion based on total weight of the hard component (optionally, optionally, tungsten carbide)-metal alloy powder blend. In some embodiments, the hard component (optionally, tungsten carbide) portion-metal alloy powder blend comprises about 60 wt % to about 90 wt %, about 70 wt % to about 90 wt %, about 60 wt % to about 85 wt % or about 65 wt % to about 85 wt % of hard component (optionally tungsten carbide) portion based on total weight of the hard component (optionally tungsten carbide)-metal alloy powder blend.

In an exemplary embodiments, the hard component portion is the hard component alone, and the hard component (optionally tungsten carbide)-metal alloy powder blend comprises
about 50 wt % to about 95 wt % of hard component (optionally tungsten carbide); and
about 5 wt % to about 50 wt % of the metal alloy of the application based on total weight of the hard component (optionally tungsten carbide)-metal alloy powder blend.

In some embodiments, the hard component (optionally, tungsten carbide)-metal alloy powder blend comprises about 50 wt % to about 90 wt %, about 60 wt % to about 90 wt %, about 70 wt % to about 90 wt %, about 75 wt % to about 90 wt %, about 80 wt % to about 90 wt %, about 85 wt % to about 90 wt %, about 50 wt % to about 85 wt %, about 60 wt % to about 85 wt %, about 65 wt % to about 85 wt %, about 70 wt % to about 85 wt %, about 80 wt % to about 85 wt %, about 50 wt % to about 80 wt %, about 60 wt % to about 80 wt %, about 65 wt % to about 80 wt %, about 70 wt % to about 80 wt %, about 75 wt % to about 80 wt %, about 50 wt % to about 75 wt %, about 60 wt % to about 75 wt %, about 65 wt % to about 75 wt %, or about 70 wt % to about 75 wt % of hard component (optionally, tungsten carbide) based on total weight of the hard component (optionally, optionally, tungsten carbide)-metal alloy powder blend. In some embodiments, the hard component (optionally, tungsten carbide)-metal alloy powder blend comprises about 60 wt % to about 90 wt %, about 70 wt % to about 90 wt %, about 60 wt % to about 85 wt % or about 65 wt % to about 85 wt % of hard component (optionally tungsten carbide) based on total weight of the hard component (optionally tungsten carbide)-metal alloy powder blend.

In some embodiments, MMCs may be formed by LPBF additive manufacturing processes using the hard component (optionally tungsten carbide) portion-metal alloy powder blend. It would be appreciated by a person skilled in the art that MMCs may be prepared by additive manufacturing processes comprises a lower amount of hard component portion compared to MMCs prepared by conventional processes. In some embodiments, the hard component (optionally tungsten carbide) portion-metal alloy powder blend comprises
about 40 wt % to about 95 wt % of a hard component (optionally tungsten carbide) portion comprising the hard component in combination with the metal alloy metal alloy of the application, or one or more of elemental Ni, Co and Fe, or mixtures thereof as described above including embodiments thereof; and
about 5 wt % to about 60 wt % of the metal alloy of the application,
based on total weight of the hard component (optionally tungsten carbide) portion-metal alloy powder blend.

In some embodiments, the hard component (optionally, tungsten carbide) portion-metal alloy powder blend comprises about 40 wt % to about 90 wt %, about 50 wt % to about 90 wt %, about 60 wt % to about 90 wt %, about 70 wt % to about 90 wt %, about 75 wt % to about 90 wt %, about 80 wt % to about 90 wt %, about 85 wt % to about 90 wt %, about 50 wt % to about 85 wt %, about 60 wt % to about 85 wt %, about 65 wt % to about 85 wt %, about 70 wt % to about 85 wt %, about 80 wt % to about 85 wt %, about 50 wt % to about 80 wt %, about 60 wt % to about 80 wt %, about 65 wt % to about 80 wt %, about 70 wt % to about 80 wt %, about 75 wt % to about 80 wt %, about 50 wt % to about 75 wt %, about 60 wt % to about 75 wt %, about 65 wt % to about 75 wt %, or about 70 wt % to about 75 wt % of hard component (optionally, tungsten carbide) portion based on total weight of the hard component (optionally, optionally, tungsten carbide)-metal alloy powder blend. In some embodiments, the hard component (optionally, tungsten carbide) portion-metal alloy powder blend comprises about 60 wt % to about 90 wt %, about 70 wt % to about 90 wt %, about 60 wt % to about 85 wt % or about 65 wt % to about 85 wt % of hard component (optionally tungsten carbide) portion based on total weight of the hard component (optionally tungsten carbide) portion-metal alloy powder blend.

In some embodiments, the hard component (optionally tungsten carbide) portion-metal alloy powder blend comprises
about 0.5 wt % to about 75 wt % of hard component portion (optionally tungsten carbide); and
about 25 wt % to about 99.5 wt % of the metal alloy of the application,
wherein all wt % based on total weight of the hard component (optionally tungsten carbide) portion-metal alloy powder blend.

In some embodiments, the hard component (optionally, tungsten carbide) portion-metal alloy powder blend comprises about 1 wt % to about 75 wt %, about 5 wt % to about 75 wt %, about 10 wt % to about 75 wt %, about 20 wt % to about 75 wt %, about 30 wt % to about 75 wt %, about 40 wt % to about 75 wt %, about 50 wt % to about 75 wt %, about 60 wt % to about 75 wt %, about 65 wt % to about 75 wt %, about 0.5 wt % to about 70 wt %, about 1 wt % to about 70 wt %, about 5 wt % to about 70 wt %, about 10 wt % to about 70 wt %, about 20 wt % to about 70 wt %, about 30 wt % to about 70 wt %, about 40 wt % to about 70 wt %, about 50 wt % to about 70 wt %, about 60 wt % to about 70 wt %, about 65 wt % to about 70 wt %, about 0.5 wt % to about 65 wt %, about 1 wt % to about 65 wt %, about 5 wt % to about 65 wt %, about 10 wt % to about 65 wt %, about 20 wt % to about 65 wt %, about 30 wt % to about 65 wt %, about 40 wt % to about 65 wt %, about 50 wt % to about 65 wt %, about 60 wt % to about 65 wt %, about 0.5 wt % to about 60 wt %, about 1 wt % to about 60 wt %, about 5 wt % to about 60 wt %, about 10 wt % to about 60 wt %, about 20 wt % to about 60 wt %, about 30 wt % to about 60 wt %, about 40 wt % to about 60 wt %, about 50 wt % to about 60 wt %, about 0.5 wt % to about 55 wt %, about 1 wt % to about 55 wt %, about 5 wt % to about 55 wt %, about 10 wt % to about 55 wt %, about 20 wt % to about 55 wt %, about 30 wt % to about 55 wt %, about 40 wt % to about 55 wt %, about 45 wt % to about 55 wt %, about 0.5 wt % to about 50 wt %, about 1 wt % to about 50 wt %, about 5 wt % to about 50 wt %, about 10 wt % to about 50 wt %, about 20 wt % to about 50 wt %, about 30 wt % to about 50 wt %, about 40 wt % to about 50 wt %, about 45 wt % to about 50 wt %, about 0.5 wt % to about 45 wt %, about 1 wt % to about 45 wt %, about 5 wt % to about 45 wt %, about 10 wt % to about 45 wt %, about 20 wt % to about 45 wt %, about 30 wt % to about 45 wt %, about 40 wt % to about 45 wt %, about 0.5 wt % to about 40 wt %, about 1 wt % to about 40 wt %, about 5 wt % to about 40 wt %, about 10 wt % to about 40 wt %, about 20 wt % to about 40 wt %, about 30 wt % to about 40 wt %, about 0.5 wt % to about 35 wt %, about 1 wt % to about 35 wt %, about 5 wt % to about 35 wt %, about 10 wt % to about 35 wt %, about 20 wt % to about 35 wt %, about 30 wt % to about 35 wt % of hard component (optionally, tungsten carbide) portion based on total weight of the tungsten carbide-metal alloy powder blend. In some embodiments, the hard component (optionally, tungsten carbide) portion-metal alloy powder blend comprises about 0.5 wt % to about 75 wt %, about 1 wt % to about 75 wt %, about 5 wt % to about 75 wt %, about 10 wt % to about 75 wt %, about 20 wt % to about 75 wt %, about 30 wt % to about 75 wt %, about 40 wt % to about 75 wt %, about 50 wt % to about 75 wt %, about 60 wt % to about 75 wt %, about 65 wt % to about 75 wt %, about 0.5 wt % to about 70 wt %, about 1 wt % to about 70 wt %, about 5 wt % to about 70 wt %, about 10 wt % to about 70 wt %, about 20 wt % to about 70 wt %, about 30 wt % to about 70 wt %, about 40 wt % to about 70 wt %, about 50 wt % to about 70 wt %, about 60 wt % to about 70 wt %, about 65 wt % to about 70 wt %, about 0.5 wt % to about 65 wt %, about 1 wt % to about 65 wt %, about 5 wt % to about 65 wt %, about 10 wt % to about 65 wt %, about 20 wt % to about 65 wt %, about 30 wt % to about 65 wt %, about 40 wt % to about 65 wt %, about 50 wt % to about 65 wt %, about 60 wt % to about 65 wt % of hard component (optionally, tungsten carbide) portion based on total weight of the hard component (optionally tungsten carbide) portion-metal alloy powder blend.

In an exemplary embodiment, the hard component (optionally tungsten carbide) portion-metal alloy powder blend comprises
about 0.5 wt % to about 70 wt % of hard component (optionally tungsten carbide) portion; and
about 30 wt % to about 99.5 wt % of the metal alloy of the application based on total weight of the tungsten carbide-metal alloy powder blend.

In an exemplary embodiment, the hard component (optionally tungsten carbide) portion-metal alloy powder blend comprises
about 0.5 wt % to about 65 wt % of hard component (optionally tungsten carbide) portion; and
about 35 wt % to about 99.5 wt % of the metal alloy of the application based on total weight of the tungsten carbide-metal alloy powder blend.

In an exemplary embodiment, the hard component (optionally tungsten carbide) portion-metal alloy powder blend comprises
about 10 wt % to about 65 wt % of hard component (optionally tungsten carbide) portion; and
about 35 wt % to about 90 wt % of the metal alloy of the application based on total weight of the tungsten carbide-metal alloy powder blend.

In an exemplary embodiment, the hard component (optionally tungsten carbide) portion-metal alloy powder blend comprises
about 65 wt % of hard component (optionally tungsten carbide) portion; and
about 35 wt % of the metal alloy of the application based on total weight of the tungsten carbide-metal alloy powder blend.

In some embodiments, the hard component portion is the hard component alone, and the hard component (optionally tungsten carbide)-metal alloy powder blend comprises
about 0.5 wt % to about 80 wt % of hard component (optionally tungsten carbide); and
about 20 wt % to about 99.5 wt % of the metal alloy of the application based on total weight of the tungsten carbide-metal alloy powder blend.

In some embodiments, the a hard component (optionally, tungsten carbide)-metal alloy powder blend comprises about 0.5 wt % to about 80 wt %, about 1 wt % to about 80 wt %, about 5 wt % to about 80 wt %, about 10 wt % to about 80 wt %, about 20 wt % to about 80 wt %, about 30 wt % to about 80 wt %, about 40 wt % to about 80 wt %, about 50 wt % to about 80 wt %, about 60 wt % to about 80 wt %, about 65 wt % to about 80 wt %, about 70 wt % to about 80 wt %, about 75 wt % to about 80 wt %, about 10 wt % to about 75 wt %, about 20 wt % to about 75 wt %, about 30 wt % to about 75 wt %, about 40 wt % to about 75 wt %, about 50 wt % to about 75 wt %, about 60 wt % to about 75 wt %, about 65 wt % to about 75 wt %, or about 70 wt % to about 75 wt %, about 0.5 wt % to about 75 wt %, about 1 wt % to about 75 wt %, about 5 wt % to about 75 wt %, about 10 wt % to about 75 wt %, about 20 wt % to about 75 wt %, about 30 wt % to about 75 wt %, about 40 wt % to about 75 wt %, about 50 wt % to about 75 wt %, about 60 wt % to about 75 wt %, about 65 wt % to about 75 wt %, about 0.5 wt % to about 70 wt %, about 1 wt % to about 70 wt %, about 5 wt % to about 70 wt %, about 10 wt % to about 70 wt %, about 20 wt % to about 70 wt %, about 30 wt % to about 70 wt %, about 40 wt % to about 70 wt %, about 50 wt % to about 70 wt %, about 60 wt % to about 70 wt %, about 65 wt % to about 70 wt %, about 0.5 wt % to about 65 wt %, about 1 wt % to about 65 wt %, about 5 wt % to about 65 wt %, about 10 wt % to about 65 wt %, about 20 wt % to about 65 wt %, about 30 wt % to about 65 wt %, about 40 wt % to about 65 wt %, about 50 wt % to about 65 wt %, about 60 wt % to about 65 wt %, about 0.5 wt % to about 60 wt %, about 1 wt % to about 60 wt %, about 5 wt % to about 60 wt %, about 10 wt % to about 60 wt %, about 20 wt % to about 60 wt %, about 30 wt % to about 60 wt %, about 40 wt % to about 60 wt %, about 50 wt % to about 60 wt %, about 0.5 wt % to about 55 wt %, about 1 wt % to about 55 wt %, about 5 wt % to about 55 wt %, about 10 wt % to about 55 wt %, about 20 wt % to about 55 wt %, about 30 wt % to about 55 wt %, about 40 wt % to about 55 wt %, about 45 wt % to about 55 wt %, about 0.5 wt % to about 50 wt %, about 1 wt % to about 50 wt %, about 5 wt % to about 50 wt %, about 10 wt % to about 50 wt %, about 20 wt % to about 50 wt %, about 30 wt % to about 50 wt %, about 40 wt % to about 50 wt %, about 45 wt % to about 50 wt %, about 0.5 wt % to about 45 wt %, about 1 wt % to about 45 wt %, about 5 wt % to about 45 wt %, about 10 wt % to about 45 wt %, about 20 wt % to about 45 wt %, about 30 wt % to about 45 wt %, about 40 wt % to about 45 wt %, about 0.5 wt % to about 40 wt %, about 1 wt % to about 40 wt %, about 5 wt % to about 40 wt %, about 10 wt % to about 40 wt %, about 20 wt % to about 40 wt %, about 30 wt % to about 40 wt %, about 0.5 wt % to about 35 wt %, about 1 wt % to about 35 wt %, about 5 wt % to about 35 wt %, about 10 wt % to about 35 wt %, about 20 wt % to about 35 wt %, about 30 wt % to about 35 wt %, of hard component (optionally, tungsten carbide) based on total weight of the tungsten carbide-metal alloy powder blend.

In an exemplary embodiment, the hard component (optionally tungsten carbide)-metal alloy powder blend comprises
about 5 wt % to about 80 wt % of hard component (optionally tungsten carbide); and
about 20 wt % to about 95 wt % of the metal alloy of the application based on total weight of the tungsten carbide-metal alloy powder blend.

In another embodiment, the hard component (optionally tungsten carbide)-metal alloy powder blend comprises
about 10 wt % to about 50 wt % of hard component (optionally tungsten carbide); and
about 50 wt % to about 90 wt % of the metal alloy of the application based on total weight of the tungsten carbide-metal alloy powder blend.

In some embodiments, the hard component (optionally, tungsten carbide) is spherical or non spherical.

A person skilled in the art would appreciate that a non spherical hard component (optionally, tungsten carbide) comprises poorer flow characteristics compared to a spherical hard component (optionally, tungsten carbide powder).

In some embodiments, the non spherical hard component (optionally tungsten carbide powder) is subjected to additional processing to improve flow characteristics of the hard component.

In some embodiments, the hard component (optionally tungsten carbide powder) is subjected to any suitable additional processing processes known in the art. In some embodiments, the hard component (optionally tungsten carbide powder) is plasma treated. In some embodiments, the plasma treatment is to provide a spherical hard component (optionally tungsten carbide powder).

In some embodiments, the hard component is spray dried in combination with the metal alloy, or one or more of elemental Ni, Co and Fe, or mixtures thereof. Therefore, in some embodiments, the hard component (optionally tungsten carbide) portion comprises a hard component (optionally tungsten carbide) in combination with the metal alloy of the application, or one or more elemental metals selected from Ni, Co and Fe, or mixtures thereof.

In some embodiments, the hard component (optionally tungsten carbide) portion comprises about 75 wt % to about 95 wt %, about 75 wt % to about 90 wt % about 75 wt % to about 85 wt %, about 75 wt % to about 80 wt %, about 80 wt % to about 95 wt %, about 80 wt % to about 90 wt % about 80 wt % to about 85 wt %, about 85 wt % to about 95 wt %, of the hard component (optionally tungsten carbide), and about 5 wt % to about 25 wt % of the metal alloy metal alloy of the application, or one or more elemental metals selected from Ni, Co and Fe, or mixtures thereof, wherein all wt % are based on the total weight of the hard component (optionally tungsten carbide) portion. In some embodiments, the hard component (optionally tungsten carbide) portion comprises about 85 wt % to about 95 wt % of the hard component (optionally tungsten carbide) and about 5 wt % to about 55 wt % of the metal alloy metal alloy of the application, or one or more elemental metals selected from Ni, Co and Fe, or mixtures thereof, wherein all wt % are based on the total weight of the hard component (optionally tungsten carbide) portion. In some embodiments, the hard component (optionally tungsten carbide) portion comprises about 85 wt % to about 95 wt % of the hard component (optionally tungsten carbide) and about 5 wt % to about 15 wt % of the metal alloy metal alloy of the application, or one or more elemental metals selected from Ni, Co and Fe, or mixtures thereof, wherein all wt % are based on the total weight of the hard component (optionally tungsten carbide) portion.

In some embodiments, the hard component (optionally tungsten carbide) portion comprises about 75 wt %, about 80 wt %, about 85 wt %, about 90 wt % or about 95 wt % of the hard component based on the total weight of the hard component (optionally tungsten carbide) portion. In some embodiments, the hard component (optionally tungsten carbide) portion comprises about 85 wt %, about 90 wt % or about 95 wt % of the hard component based on the total weight of the hard component (optionally tungsten carbide) portion. In some embodiments, the hard component (optionally tungsten carbide) portion comprises about 90 wt % of the hard component (optionally tungsten carbide), wherein all wt % are based on the total weight of the hard component (optionally tungsten carbide) portion.

In some embodiments, the hard component (optionally tungsten carbide) portion comprises about 5 wt %, about 10 wt %, about 15 wt %, about 20 wt % or about 25 wt % of the metal alloy the application, or one or more of elemental Ni, Co and Fe, or mixtures thereof, wherein all wt % are based on the total weight of the hard component portion. In some embodiments, the hard component (optionally tungsten carbide) portion comprises about 5 wt %, about 10 wt % or about 15 wt % of the metal alloy metal alloy of the application, or one or more of elemental Ni, Co and Fe, or mixtures thereof, wherein all wt % are based on the total weight of the hard component portion. In some embodiments, the hard component portion comprises about 10 wt % of the metal alloy metal alloy of the application, or one or more elemental metals selected from Ni, Co and Fe, or mixtures thereof, wherein all wt % are based on the total weight of the hard component (optionally tungsten carbide) portion.

In some embodiments, the hard component (optionally tungsten carbide) portion comprises about 90 wt % of the hard component (optionally tungsten carbide) and about 10 wt % of the metal alloy of the application, or one or more elemental metals selected from Ni, Co and Fe, or mixtures thereof, wherein all wt % are based on the total weight of the hard component (optionally tungsten carbide) portion.

In some embodiments, the hard component (optionally tungsten carbide) portion comprise the hard component (optionally tungsten carbide) and the metal alloy powder of the application. In some embodiments, the hard component (optionally tungsten carbide) portion comprises the hard component (optionally tungsten carbide) and one or more elemental metals selected from Ni, Co and Fe. In some embodiments, the hard component (optionally tungsten carbide) portion comprises the hard component (optionally tungsten carbide) and elemental Ni.

In some embodiments, the hard component (optionally tungsten carbide) portion about 75 wt % to about 95 wt %, about 75 wt % to about 90 wt % about 75 wt % to about 85 wt %, about 75 wt % to about 80 wt %, about 80 wt % to about 95 wt %, about 80 wt % to about 90 wt % about 80 wt % to about 85 wt %, about 85 wt % to about 95 wt %, of the hard component (optionally tungsten carbide), and about 5 wt % to about 25 wt % about 5 wt %, about 10 wt %, about 15 wt %, about 20 wt % or about 25 wt % of elemental Ni, based on the total weight of the hard component portion, all wt % based on the total weight of the hard component portion. In some embodiments, the hard component (optionally tungsten carbide) portion about 80 wt % to about 95 wt %, of the hard component (optionally tungsten carbide), and about 5 wt % to about 15 wt % of elemental Ni, based on the total weight of the hard component portion, all wt % based on the total weight of the hard component portion. In an exemplary embodiment, the hard component (optionally tungsten carbide) is spray dried in combination with elemental Ni, and the hard component (optionally tungsten carbide) portion comprises the hard component (optionally tungsten carbide) and elemental Ni. In some embodiments, the hard component (optionally tungsten carbide) portion comprises about 90 wt % of the hard component (optionally tungsten carbide) and about 10 wt % of elemental Ni, based on the total weight of the hard component (optionally tungsten carbide) portion.

In an exemplary embodiment, the hard component (optionally tungsten carbide) portion-metal alloy powder blend comprises
about 0.5 wt % to about 70 wt % of hard component (optionally tungsten carbide) portion, based on total weight of the tungsten carbide-metal alloy powder blend; and
about 30 wt % to about 99.5 wt % of the metal alloy of the application, based on total weight of the tungsten carbide-metal alloy powder blend,
wherein the hard component (optionally tungsten carbide) portion comprises about 85 wt %, about 90 wt % or about 95 wt % of a hard component and about 5 wt %, about 10 wt % or about 15 wt % of elemental Ni, based on the total weight of the hard component portion.

In an exemplary embodiment, the hard component (optionally tungsten carbide) portion-metal alloy powder blend comprises
about 0.5 wt % to about 65 wt % of hard component (optionally tungsten carbide) portion, based on total weight of the tungsten carbide-metal alloy powder blend; and
about 35 wt % to about 99.5 wt % of the metal alloy of the application, based on total weight of the tungsten carbide-metal alloy powder blend,
wherein the hard component (optionally tungsten carbide) portion comprises about 85 wt %, about 90 wt % or about 95 wt % of a hard component and about 5 wt %, about 10 wt % or about 15 wt % of elemental Ni, based on the total weight of the hard component portion.

In an exemplary embodiment, the hard component (optionally tungsten carbide) portion-metal alloy powder blend comprises
about 10 wt % to about 65 wt % of hard component (optionally tungsten carbide) portion, based on total weight of the tungsten carbide-metal alloy powder blend; and
about 35 wt % to about 90 wt % of the metal alloy of the application based on total weight of the tungsten carbide-metal alloy powder blend.
wherein the hard component (optionally tungsten carbide) portion comprises about 85 wt %, about 90 wt % or about 95 wt % of a hard component and about 5 wt %, about 10 wt % or about 15 wt % of elemental Ni, based on the total weight of the hard component portion.

In an exemplary embodiment, the hard component (optionally tungsten carbide) portion comprises about 90 wt % of the hard component and about 10 wt % elemental Ni, based on the total weight of the hard component (optionally tungsten carbide) portion.

In an exemplary embodiment, the hard component (optionally tungsten carbide) portion-metal alloy powder blend comprises
about 65 wt % of hard component (optionally tungsten carbide) portion, based on total weight of the tungsten carbide-metal alloy powder blend; and
about 35 wt % of the metal alloy of the application based on total weight of the tungsten carbide-metal alloy powder blend.
wherein the hard component (optionally tungsten carbide) portion comprises about 90 wt % of a hard component and about 10 wt % elemental Ni, based on the total weight of the hard component (optionally tungsten carbide) portion.

In some embodiments, the spray drying comprise forming a slurry of the hard component (optionally tungsten carbide powder) and the metal alloy powder, the one or more of elemental Ni, Co and Fe or mixtures thereof (optionally elemental Ni), and atomizing the slurry to provide an atomized (granular) hard component portion. In some embodiments, the atomized hard component (optionally, tungsten carbide) portion is further dried. In some embodiments, spray drying provides a hard component (optionally, tungsten carbide) portion wherein the hard component (optionally tungsten carbide powder) is coated by the metal alloy or the one or more of elemental Ni, Co and Fe or mixtures thereof (optionally elemental Ni), to provide improve flow characteristics of the hard component portion-metal alloy powder blend.

In some embodiments, the hard component (optionally, tungsten carbide) portion-metal alloy powder blend is prepared by blending the hard component (optionally tungsten carbide powder) portion with the metal alloy powder by any suitable method of blending known in the art. In some embodiments, blending the hard component (optionally tungsten carbide) portion with the metal alloy powder is by mechanical mixing, planetary milling or ball milling.

In some embodiments, the tungsten carbide portion comprising about 90 wt % of tungsten carbide and about 10 wt % of elemental Ni, based on the total weight of the tungsten carbide portion is commercially available such as WallCarb™ 90/10 (WC-10Ni) (WallColMonoy Surfacing Alloys, Michigan, USA), In some embodiments, the tungsten carbide (optionally, powdered tungsten carbide) is available from commercial sources. For example, in some embodiments, tungsten carbide is available from Indurate Alloys Inc., (Alberta, Canada).

In some embodiments, the tungsten carbide is spherical cast tungsten carbide, angular cast tungsten carbide or macro-crystalline tungsten carbide or combinations thereof. In some embodiments, tungsten carbide is angular cast tungsten carbide.

In some embodiments, the tungsten carbide is used as provided by the manufacturer. In some embodiments, the tungsten carbide is subjected to additional processing such as spray drying as described above.

In some embodiments, the tungsten carbide powder has a particle size of about 10 μm to about 50 μm. In some embodiments, the tungsten carbide powder has a particle size of less than about 60 μm (i.e., each of the tungsten carbide particles has a particle size of less than 60 μm), about 55 μm, about 50 μm, about 45 μm or about 40 μm. In some embodiments, the tungsten carbide powder has a particle size of less than about 50 μm, about 45 μm or about 40 μm.

In an alternative embodiment, the metal mixture of the application is used in place of the metal alloy in any of the embodiments herein, to provide a hard component-metal mixture powder blend.

Metal matrix composites (MMCs) and LPBF manufactured MMC products of the application

The hard component (optionally tungsten carbide) portion-metal alloy powder blend of the application can be used for preparing metal matrix composite (MMCs) such as cemented carbides. In some embodiments, the metal matrix composite are prepared by conventional methods. In some embodiments, the metal matrix composite is prepared in situ by a LPBF additive manufacturing process. Therefore, in some embodiments, LPBF additive manufacturing of the hard component (optionally tungsten carbide) portion-metal alloy powder blend provides a LPBF manufactured MMC (e.g., cemented carbide) and a LPBF manufactured MMC product.

Therefore, in some embodiments, the application further includes a metal matrix composite comprising the metal alloy of the application and which may be formed from the hard component (optionally tungsten carbide) portion-metal alloy powder blend of the application. Accordingly, in some embodiments, the application includes a metal matrix composite comprising the metal alloy of the application including embodiment thereof. In some embodiments, the application includes a metal matrix composite comprising the hard component portion-metal alloy powder blend (optionally the tungsten carbide portion-metal alloy powder blend) of the application. Therefore, in some embodiments, the application includes a metal matrix composite comprising a hard component portion and a metal alloy wherein the hard component and a metal alloy are present in the MMC in substantially the same wt % as the wt % of hard component portion and a metal alloy in the hard component portion-metal alloy powder blend (optionally the tungsten carbide portion-metal alloy powder blend) of the application. In some embodiments, the metal alloy powder of the application and hard component portion-metal alloy powder blend of the application is as described above under “Metal alloy” and “Hard component portion-metal alloy powder blend of the application” including all embodiments thereof described above.

Accordingly, in an embodiment, the MMC comprises a hard component portion-metal alloy powder blend (optionally the tungsten carbide portion-metal alloy powder blend), wherein the hard component portion-metal alloy powder blend (optionally the tungsten carbide portion-metal alloy powder blend) comprises
about 0.5 wt % to about 95 wt % of a hard component (optionally, tungsten carbide) portion (and including embodiments thereof describe above); and
about 5 wt % to about 99.5 wt % of the metal alloy of the application based on total weight of the hard component (optionally tungsten carbide) portion-metal alloy powder blend (and including embodiments thereof describe above).

In some embodiments, the metal matrix composite is formed by any conventional method known in the art for providing metal matrix composites. In some embodiments, the metal matrix composite is prepared by hot pressing, cold pressing, low-pressure sintering, extrusion, pressureless sintering, or metal injection molding.

In an exemplary embodiment, the metal matrix composite comprise about 50 wt % to about 95 wt % of hard component (optionally tungsten carbide) portion; and
about 5 wt % to about 50 wt % of the metal alloy of the application based on total weight of the MMC.

In some embodiments, the metal matrix composite is formed in situ using laser powder bed fusion (LPBF) additive manufacturing.

Therefore, the application further includes laser powder bed fusion (LPBF) additively manufactured MMC product prepared from the hard component portion-metal alloy powder blend (optionally the tungsten carbide portion-metal alloy powder blend) of the application.

In an exemplary embodiment, the present application includes a laser powder bed fusion (LPBF) additively manufactured MMC product comprising
about 0.5 wt % to about 70 wt % of a hard component (optionally tungsten carbide) portion; and
about 30 wt % to about 99.5 wt % of a metal alloy of the application based on total weight the MMC produce.

In an exemplary embodiment, present application includes a laser powder bed fusion (LPBF) additively manufactured MMC product comprising
about 0.5 wt % to about 65 wt % of a hard component (optionally tungsten carbide) portion; and
about 35 wt % to about 99.5 wt % of a metal alloy of the application based on total weight of the MMC product.

In an exemplary embodiment, present application includes a laser powder bed fusion (LPBF) additively manufactured MMC product comprising
about 10 wt % to about 65 wt % of hard component (optionally tungsten carbide) portion; and
about 35 wt % to about 90 wt % of the metal alloy of the application based on total weight of the MMC product.

In an exemplary embodiment, present application includes a laser powder bed fusion (LPBF) additively manufactured MMC product comprising
about 65 wt % of hard component (optionally tungsten carbide) portion; and
about 35 wt % of the metal alloy of the application based on total weight of the MMC product.

In some embodiments, the hard component (optionally tungsten carbide) portion and amounts thereof are as described above including embodiments thereof.

In some embodiments, the metal alloy of the application is as described and amounts thereof are as described above including embodiments thereof.

In an exemplary embodiment, the laser powder bed fusion (LPBF) additively manufactured MMC comprises
about 0.5 wt % to about 80 wt % of hard component (optionally tungsten carbide) portion; and
about 20 wt % to about 99.5 wt % of the metal alloy of the application based on total weight of the hard component (optionally tungsten carbide) portion-metal alloy powder blend.

In an exemplary embodiment, the laser powder bed fusion (LPBF) additively manufactured MMC comprises
about 10 wt % to about 80 wt % of hard component (optionally tungsten carbide) portion; and
about 20 wt % to about 90 wt % of the metal alloy of the application based on total weight of the tungsten carbide portion-metal alloy powder blend.

In an exemplary embodiment, the laser powder bed fusion (LPBF) additively manufactured MMC comprises
about 10 wt % to about 50 wt % of hard component (optionally tungsten carbide) portion; and
about 50 wt % to about 90 wt % of the metal alloy of the metal alloy of the application based on total weight of the tungsten carbide portion-metal alloy powder blend

In some embodiments, the surface roughness of the MMC or LPBF manufactured MMC product can be measured using any suitable methods for measuring surface roughness known in the art. For example, the surface roughness of the MMC or LPBF manufactured MMC product is measured using the methods disclosed in the International Organization for Standardization (ISO), e.g., ISO 468:1982.

In some embodiments, surface roughness is measured by arithmetic mean deviations (i.e., “Ra”) and/or maximum height (i.e., “Rz”)

In some embodiments, the MMC or LPBF manufactured MMC product structure may be substantially free of cracks.

As used herein, “substantially free of cracks” means that at least 99 vol % of the metal alloy contains no linear or tortuous cracks that are greater than 0.1 μm in width or greater than 10 μm in length.

In some embodiments, at least 99, at least 99.1, at least 99.2, at least 99.3, at least 99.4, at least 99.5, at least 99.6, at least 99.7, at least 99.8, at least 99.9 vol % the metal alloy contains no linear or tortuous cracks that are greater than 0.1 μm in width or greater than 10 μm in length.

The LPBF manufactured MMC products of the application were observed to be crack free using scanning electron micrographs.

In some embodiments, the MMC or LPBF manufactured MMC products comprise improved densities compared to otherwise identical MMC or LPBF manufactured MMC product except comprising a conventional binder such as cobalt only binder.

To be clear, every increment between the endpoints of ranges disclosed herein is encompassed herein as if it were specifically stated, unless otherwise stated. For example, range of about 40 wt. % to 90 wt. % encompasses about 1 wt. % increments thereby specifically including 40 wt. %, 41 wt. %, 42 wt. %, . . . 88 wt. %, 89 wt. %, and 90 wt. %. Further for example, a ratio range of about 1.5:1 to 1:1.5 encompasses about 0.1 increments thereby specifically including 1.5:1, 1.4:1, . . . 1:1, . . . 1:1.4, and 1:1.5). Furthermore, for example, a range of about 0.1 μm to about 40 μm encompasses about 1 μm increments thereby specifically including about 1 μm, 2 μm, 3 μm, . . . 38 μm, 39 μm, and 40 μm.

### III. Methods and Uses of the Application

The metal alloy of the application has been shown to be useful in forming, along with a hard component portion such as tungsten carbide or processed tungsten carbide, a hard component portion-metal alloy powder blend of the application which in turn can be used for forming MMC by conventional methods, or as a feedstock to form metal matrix composites, for example, in situ using LPBF additive manufacturing. The metal alloy has also been shown to be useful as a feedstock on its own (i.e, without a hard component portion) for LPBF additive manufacturing to form a LPBF additive manufactured product.

Accordingly, the present application also includes a method of preparing a manufacturing metal matrix composite (MMC) of the application comprising:
providing a hard component portion-metal alloy powder blend (optionally, tungsten carbide portion-metal alloy powder blend) of the application as a feedstock material in a LPBF apparatus, and
LPBF additively manufacturing the MMC product.

The present application also includes a method of LPBF additive manufacturing metal matrix composite (MMC) products of the application comprising:
providing a hard component portion-metal alloy powder blend (optionally, tungsten carbide portion-metal alloy powder blend) of the application as a feedstock material in a LPBF apparatus, and
LPBF additively manufacturing the MMC product.

Also included is a method for reducing cracking and/or porosity of a LPBF additively manufactured MMC product comprising:
providing a hard component portion-metal alloy powder blend (optionally, tungsten carbide portion-metal alloy powder blend) of the application as a feedstock material in a LPBF apparatus, and
LPBF additively manufacturing the MMC product.

Also included is a method for improving wear resistance of a LPBF additively manufactured MMC product comprising:
providing a hard component portion-metal alloy powder blend (optionally, tungsten carbide portion-metal alloy powder blend) of the application as a feedstock material in a LPBF apparatus, and
LPBF additively manufacturing the MMC product.

The present application also includes a method of LPBF additive manufacturing a products comprising:
providing a metal alloy powder of the application as a feedstock material in a LPBF apparatus, and
LPBF additively manufacturing the product.

In some embodiment, the step of LPBF additively manufacturing the MMC product comprises:
dispersing the feedstock material (e.g. hard component portion-metal alloy powder blend or tungsten carbide portion-metal alloy powder blend of the application) to form a powder bed layer in the LPBF apparatus;
melting at least of portion of the powder bed layer of feedstock material to form a melted powder bed layer of feedstock material;
solidifying the melted powder bed layer of feedstock material, and repeating the steps of dispersing, melting and solidifying to, layer by layer, provide the MMC product.

Accordingly, LPBF additively manufactured MMC product comprises the metal alloy of the application as described above and a hard component portion (optionally tungsten carbide portion) as described above.

In some embodiments, the LPBF manufactured product comprises the metal alloy of the application as the matrix.

In some embodiments, the reduced microcracking and/or porosity is compared to an otherwise identical LPBF additive manufactured product except using a feedstock that comprises a conventional binder such as cobalt binder known in the art.

In some embodiments, the melting is at a temperature of about 600° C. to about 850° C.

In some embodiments, the powder bed layer is formed on a base plate of the LPBF apparatus.

In some embodiments, the base plate is at room temperature (about 18° C. to about 25° C.). In some embodiments, the base plate is heated. In some embodiments, the base plate is heated to about 35 C to about 500° C.

In some embodiments, the laser powder bed fusion is selected from selective laser sintering (SLS), selective laser melting (SLM) and direct metal laser sintering (DMLS).

In some embodiments, the laser is operated at a power of about 150 W to about 400 W, about 200 W to about 400 W, about 200 W to about 350 W, about 200 W to about 300 W, about 200 W to about 250 W. In some embodiments, the laser is operated at a power of about 400 W. In some embodiments, the laser is operated at a power of about 200 W to about 250 W.

In some embodiments, the laser is operated at a marking speed of about 250 mm/s to about 2500 mm/s, about 250 mm/s to about 2000 mm/s, about 250 mm/s to about 1500 mm/s, about 250 mm/s to about 1250 mm/s, about 250 mm/s to about 1000 mm/s, about 300 mm/s to about 2500 mm/s, about 300 mm/s to about 2000 mm/s, about 300 mm/s to about 1500 mm/s, about 300 mm/s to about 1250 mm/s, about 300 mm/s to about 1000 mm/s, about 300 mm/s to about 800 mm/s, about 300 mm/s to about 600 mm/s, about 500 mm/s to about 2500 mm/s, about 500 mm/s to about 2000 mm/s, about 500 mm/s to about 1500 mm/s, about 500 mm/s to about 1250 mm/s, about 500 mm/s to about 1000 mm/s. In some embodiments, the laser is operated at a marking speed of about 250 mm/s to about 2500 mm/s, about 250 mm/s to about 2000 mm/s, about 250 mm/s to about 1500 mm/s, about 250 mm/s to about 1250 mm/s, about 250 mm/s to about 1000 mm/s, about 500 mm/s to about 2500 mm/s, about 500 mm/s to about 2000 mm/s, about 500 mm/s to about 1500 mm/s, about 500 mm/s to about 1250 mm/s, about 500 mm/s to about 1000 mm/s. In some embodiments, the laser is operated at a marking speed of 500 mm/s to about 1000 mm/s. In some embodiments, the laser is operated at a marking speed of about 250 mm/s to about 1000 mm/s, about 300 mm/s to about 1000 mm/s, about 300 mm/s to about 800 mm/s, or about 300 mm/s to about 600 mm/s. In some embodiments, the laser is operated at a marking speed of about 250 mm/s to about 1000 mm/s, about 300 mm/s to about 1000 mm/s, about 300 mm/s to about 800 mm/s, or about 300 mm/s to about 600 mm/s. In some embodiments, the hatch distance is about 10 μm to about 200 μm, about 25 μm to about 150 μm, about 25 μm to about 100 μm, about 25 μm to about 75 μm, about 30 μm to about 100 μm, about 30 μm to about 75 μm, about 30 μm to about 70 μm, about 50 μm to about 150 μm or about 50 μm to about 100 μm. In some embodiments, the hatch distance is about 10 μm to about 200 μm, about 25 μm to about 150 μm, about 25 μm to about 100 μm, about 50 μm to about 150 μm or about 50 μm to about 100 μm. In some embodiments, the hatch distance is about 50 μm to about 150 μm or about 50 μm to about 100 μm. In some embodiments, the hatch distance is about 25 μm to about 100 μm, about 25 μm to about 75 μm, about 30 μm to about 100 μm, about 30 μm to about 75 μm or about 30 μm to about 70 μm. In some embodiments, the hatch distance is about 30 μm to about 70 μm.

In some embodiments, the layer has a thickness of about 25 μm, 30 μm, about 35 μm, about 40 μm, about 45 μm, about 50 μm, about 55 μm, about 60 μm, or about 65 μm. In some embodiments, the layer has a thickness of about 40 μm, about 45 μm, about 50 μm or about 55 μm. In some embodiments, the layer has a thickness of about 50 μm. In some embodiments, the layer has a thickness of about 25 μm to about 100 μm about 25 μm to about 75 μm, about 40 μm to about 80 μm, about 40 μm to about 60 μm or about 45 μm to about 55 μm. In some embodiments, the layer has a thickness of about 25 μm to about 100 μm about 25 μm to about 75 μm, about 30 μm to about 75 μm, about 30 μm to about 60 μm, about 40 μm to about 80 μm, about 40 μm to about 60 μm or about 45 μm to about 55 μm. In some embodiments, the layer has a thickness of about 25 μm to about 75 μm, about 30 μm to about 75 μm or about 30 μm to about 60 μm. In some embodiments, the layer has a thickness of about 30 μm to about 60 μm. In some embodiments, the layer has a thickness of about 25 μm, 30 μm, about 35 μm, about 40 μm, about 45 μm, about 50 μm, about 55 μm, about 60 μm, or about 65 μm. In some embodiments, the layer has a thickness of about 40 μm, about 45 μm, about 50 μm or about 55 μm. In some embodiments, the layer has a thickness of about 50 μm.

The present application also includes the use of the metal mixture of the application for preparing a metal alloy of the application. The present application also includes the use of the metal mixture of the application for preparing a hard component-metal mixture powder blend (optionally, tungsten carbide-metal alloy powder blend) of the application. The present application also includes the use of a metal mixture of the application for preparing a hard component-metal alloy powder blend (optionally, tungsten carbide-metal alloy powder blend) of the application for manufacturing MMCs (e.g. cemented carbides). The present application also includes the use of a metal mixture of the application for preparing a hard component-metal alloy powder blend (optionally, tungsten carbide-metal alloy powder blend) of the application for LPBF manufacturing MMCs (e.g. cemented carbides) or LPBF manufacturing MMC products.

The present application also includes the use of a metal alloy powder of the application for preparing a hard component portion-metal alloy powder blend (optionally, tungsten carbide portion-metal alloy powder blend) of the application. The present application also includes the use of a metal alloy powder of the application for preparing a hard component portion-metal alloy powder blend (optionally, tungsten carbide portion-metal alloy powder blend) of the application for manufacturing MMCs (e.g. cemented carbides). The present application also includes the use of a metal alloy powder of the application for preparing a hard component portion-metal alloy powder blend (optionally, tungsten carbide-metal alloy powder blend) of the application for LPBF manufacturing MMCs (e.g. cemented carbides) or LPBF manufacturing MMC products.

The present application also includes the use of a metal alloy powder of the application for LPBF additively manufacturing products. The present application also includes the use of a metal alloy as a feedstock for LPBF additive manufacturing.

The present application also includes the use of a hard component portion-metal alloy powder blend (optionally, tungsten carbide portion-metal alloy powder blend) of the application for manufacturing MMCs (e.g. cemented carbides). The present application also includes the use of a hard component portion-metal alloy powder blend (optionally, tungsten carbide portion-metal alloy powder blend) for LPBF additively manufacturing MMCs (e.g. cemented carbides) or LPBF additively manufactured MMC products. Therefore, the present application also includes the use of metal alloy powder of the application for preparing an hard component portion-metal alloy powder blend (optionally, tungsten carbide-metal alloy powder blend) as a feedstock for LPBF additive manufacturing.

In some embodiments, the MMC and/or additive manufactured MMC products produced by the method of the present application have reduced microcracking, reduced porosity, increased strength, wear resistance and/or increased thermal conductivity compared to otherwise identical MMC and/or LPBF manufactured MMC product except comprising a conventional binder such as cobalt only binder. In some embodiments, the MMC and/or additive manufactured MMC products produced by the method of the present application also have increased wear resistance compared to otherwise identical MMC and/or LPBF manufactured MMC product except comprising a conventional binder such as cobalt only binder.

The present application also include the use of metal alloy powder of the application and/or the hard component portion-metal alloy powder blend (optionally, tungsten carbide portion-metal alloy powder blend) of the application for reducing microcracking in LPBF additive manufactured products, for reducing porosity in LPBF additive manufactured products, for increasing strength in LPBF additive manufactured products, for increasing wear resistance in LPBF additive manufactured products, and/or for increasing thermal conductivity in LPBF additive manufactured products.

In some embodiments, the LPBF additively manufactured MMC or MMC products are metalworking and machining products, aerospace products, automotive products, tooling and manufacturing products, electronic products, semiconductor products or medical products.

In some embodiments, the LPBF additively manufactured MMC or MMC products are for use in one or more of the industries, industry sectors and application areas listed in Table 1.

TABLE 1

| Industry | Sectors | Applications |
|---|---|---|
| Metalworking & | Manufacturing, Tooling, | Cutting tools (milling cutters, |
| Machining | Automotive, Aerospace | drills, inserts), wear-resistant |
| | | dies |
| Mining & Drilling | Mining, Oil & Gas, | Drill bits, cutting tools, |
| | Construction | excavation equipment, roller |
| | | cutters, hammer tools |
| Automotive | Vehicle Manufacturing, Auto | Valve seats, inserts, high- |
| | Parts | performance |
| | | brake systems |
| Aerospace | Aerospace Manufacturing, | Jet engine components |
| | Defense | (blades, seals), aerospace |
| | | tooling |
| Energy | Oil & Gas, Renewable | Valves, seals, pumps, |
| | Energy | compressors, subsea |
| | | components |
| Tooling and | General Manufacturing, | Wear-resistant tools, |
| Manufacturing | Heavy Industry | extrusion dies, |
| | | pressing/forming tools |
| Construction | Construction Equipment, | Cutting tools for |
| | Infrastructure | concrete/asphalt, wear parts |
| | | for heavy machinery |
| Electronics & | Electronics Manufacturing, | Microelectronics tooling, |
| Semiconductors | Semiconductor Fabrication | polishing/grinding tools for |
| | | wafers |
| Medical Devices | Medical Device | Surgical tools (scalpels, |
| | Manufacturing, Healthcare | bone saws), orthopedic |
| | | implants |

### IV. Methods of Preparing the Compositions of the Application

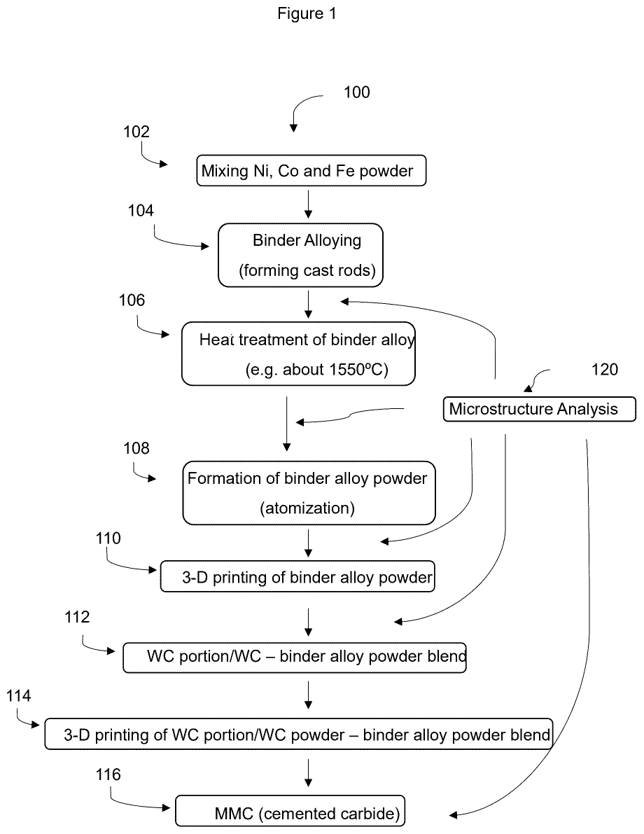

In some embodiments, referring to the flowchart of FIG. 1, the method of preparing the MMC (e.g. cemented carbide) or LPBF additively manufactured MMC products of the application 100 begins with preparing a metal mixture by mixing Ni, Co and Fe powders 102. In some embodiments, the Ni, Co and Fe are present in the metal mixture in an atomic % and/or wt % that is the same as the atomic % and/or wt % for Ni, Co and Fe in the metal alloy described above including embodiments thereof.

In some embodiments, the method proceeds to the step of preparing a metal alloy 104 (i.e., alloying) from the binder mixture. Therefore, in some embodiments, the application includes preparing a metal alloy from the binder mixture. In some embodiments, the metal alloy is prepared by any suitable method of alloying known in the art. In some embodiments, the metal alloy is prepared by casting or sintering such as vacuum sintering. In some embodiments, the metal alloy is prepared by casting. Therefore, in some embodiments, the metal alloy is a casted metal alloy. In some embodiments, the metal alloy is a cast strip or cast rod.

In some embodiments, metal alloy is heat treated 106. In some embodiments, the metal alloy is heat treated at a temperature of about 1500° C. to about 1600° C., about 1525° C. to about 1575° C. or about 1550° C. In some embodiments, the metal alloy is heat treated at a temperature of about 1550° C. In some embodiments, the metal alloy is heat treated using any method of heat treatment known in the art. In some embodiments, the heat treating is plasma heat treating. In some embodiments, the metal alloy is heat treated for about 30 minutes to about 120 minutes, about 30 minutes to about 90 hours, about 45 minutes to about 75 minutes, or about 45 minutes, 60 minutes, or about 75 minutes. In some embodiments, the metal alloy is heat treated for about 60 minutes.

In some embodiments, the method then proceeds to the step of forming a metal alloy powder 108. In some embodiments, the metal alloy powder is prepared using any suitable methods of preparing a powder from an alloy known in the art. In some embodiments, the powder is prepared by atomization (i.e., spray granulation), milling such as ball milling and attribitor milling, cryomilling, laser ablation, electron-discharge machining, wire explosion, electrode induction melting or spheriodization. In some embodiments, powder is prepared by atomization. In some embodiments, the atomization is gas atomization or plasma atomization. In some embodiments, the atomization is gas atomization. In an exemplary embodiment, the metal alloy is atomized (optionally gas atomized) to provide a metal alloy powder suitable for use in laser powder bed fusion.

In some embodiments, the method proceed to the step of additively manufacturing the metal alloy powder 110. In some embodiments, the step of additively manufacturing the metal alloy powder is to determine optimal set of LPBF additive manufacturing parameters including, but not limited to, laser power, hatch distance, marking speed, and layer thickness.

In some embodiments, the method proceeds to the step of preparing the hard component portion-metal alloy powder blend (optionally the tungsten carbide portion-metal alloy powder blend) 112. In some embodiments, the hard component portion-metal alloy powder blend (optionally, tungsten carbide portion-metal alloy powder blend) is as described herein under “Metal matrix composite and LPBF manufactured product of the application” including all embodiments thereof. In some embodiments, the hard component portion-metal alloy powder blend (optionally the tungsten carbide portion-metal alloy powder blend) is prepared using any suitable methods of preparing a blend known in the art

Therefore, in some embodiments, the present application further includes a method of preparing a hard component portion-metal alloy powder blend (optionally, tungsten carbide-metal alloy powder blend) of the application, the method comprising,
blending the metal alloy powder of the application with a powder hard component portion (optionally powdered tungsten carbide portion) to provide the hard component portion-metal alloy powder blend (optionally, tungsten carbide portion-metal alloy powder blend) of the application.

Also included is a method of preparing a hard component portion-metal alloy powder blend (optionally, tungsten carbide-metal alloy powder blend) of the application for use as substrate material in LPBF additive manufacturing, the method comprising,
blending the metal alloy powder of the application with a powder hard component portion (optionally powdered tungsten carbide portion) to provide the hard component portion-metal alloy powder blend (optionally, tungsten carbide portion-metal alloy powder blend) of the application.

In some embodiments, the blending is by any suitable method of blending known in the art. In some embodiments, the blending is by mechanical mixing, planetary mixing, ball mixing, high shear mixing and dry coating.

Alternatively, in some embodiments, the hard component portion-metal alloy powder blend (optionally the tungsten carbide (WC) portion-metal alloy powder blend) 112 is prepared directly from the metal mixture prepared by mixing elemental Ni, Co and Fe powders 102.

In some embodiments, the method next proceeds to preparing the metal matrix composite (e.g. cemented carbide) 116 from hard component portion-metal alloy powder blend (optionally the tungsten carbide (WC) portion-metal alloy powder blend).

In some embodiments, the metal matrix composite is formed by any conventional method known in the art for providing metal matrix composites. In some embodiments, the metal matrix composite is prepared by hot pressing, cold pressing, low-pressure sintering, extrusion, pressureless sintering, or metal injection molding.

In some embodiments, the metal matrix composite 116 is formed by LPBF additive manufacturing 114. In some embodiments, the LPBF additive manufacturing comprises using the laser power, hatch distance, marking speed, and layer thickness as described above.

In some embodiments, the method further comprises analyzing the microstructure 120 of one or more of the metal alloy, the heat treated metal alloy, the metal alloy powder, the LPBF additively manufactured metal alloy powder, and the MMC/LPBF additively manufactured MMC.

### Numbered Embodiments of the Application

1. A metal alloy comprising at least about 30 wt % of nickel (Ni) but not more than about 58 wt % of nickel (Ni), at least about 21 wt % cobalt (Co) and at least about 21% wt % of iron (Fe).
2. The metal alloy of embodiment 1, wherein the metal alloy comprises
about 34 wt % to about 58 wt % of nickel (Ni);
about 21 wt % to about 33 wt % of cobalt (Co); and
about 21 wt % to about 33 wt % of iron (Fe), based on the total weight of the metal alloy.
3. The metal alloy of embodiment 2, wherein the metal alloy comprises about 34 wt % to about 54 wt % Ni; about 35 to about 53 wt % Ni; about 36 wt % to about 52 wt % Ni; about 37 wt % to about 51 wt % Ni; about 38 wt % to about 50 wt % Ni, about 40 wt % to about 48 wt % Ni; about 41 wt % to about 47 wt % Ni, about 42 wt % to about 46 wt %; about 43 wt % to about 45 wt % Ni based on the total weight of the metal alloy.
4. The metal alloy of any one of embodiment 1 to 3, wherein the metal alloy comprises about 24 wt % to about 32 wt % Co; about 25 wt % to about 31 wt % Co; about 26 wt % to about 30 wt % Co; or about 27 wt % to about 29 wt % Co.
5. The metal alloy any one of embodiment 1 to 4, wherein the metal alloy comprises about 24 wt % to about 32 wt % Fe; about 25 wt % to about 31 wt % Fe; about 26 wt % to about 30 wt % Fe; or about 27 wt % to about 29 wt % Fe.
6. The metal alloy of embodiment 1, wherein the metal alloy comprises
about 34 wt % to about 54 wt % of nickel (Ni);
about 23 wt % to about 33 wt % of cobalt (Co); and
about 23 wt % to about 33 wt % of iron (Fe), based on the total weight of the
7. The metal alloy of embodiment 1, wherein the metal alloy comprises
about 42 to about 46 wt % of nickel (Ni);
about 27 to about 29 wt % of cobalt (Co); and
about 27 to about 29 wt % of iron (Fe), based on the total weight of the metal alloy.
8. The metal alloy of embodiment 1, wherein the metal alloy comprises
about 43 to about 45 wt % of nickel (Ni);
about 28 to about 29 wt % of cobalt (Co); and
about 27 to about 28 wt % of iron (Fe), based on the total weight of the metal alloy.
9. The metal alloy of any one of embodiment 1 to 8, wherein the metal alloy is heat treated to provide a heat-treated metal alloy.
10. The metal alloy of any of embodiment 1 to 9, wherein the metal alloy is formed into a metal alloy powder and the metal alloy powder comprises a D₉₀ of about 65 μm to about 75 μm, about 70 μm to about 80 μm or about 70 μm to about 75 μm.
11. The metal alloy of embodiment 10, wherein the metal alloy powder comprises a Hall flow rate of about 18 seconds or less, about 17 seconds or less, about 16 seconds or less, about 15 seconds or less, about 14 seconds or less or about 13 seconds or less.
12. The metal alloy of any of embodiment 1 to 10, wherein the metal alloy has an alloy purity of at least 98 wt %, at least 99 wt %, at least 99.1 wt %, at least 99.2 wt %, at least 99.3 wt %, at least 99.4 wt %, or at least 99.5 wt %, based on the total weight of the metal alloy.
13. The metal alloy of any of embodiment 1 to 11, wherein the metal alloy is for use in laser powder bed fusion (LPBF) additive manufacturing.
14. A tungsten carbide portion-metal alloy powder blend comprising
about 0.5 wt % to about 95 wt % of a tungsten carbide portion; and
about 5 wt % to about 99.5 wt % of the metal alloy of any one of embodiments 1 to 13 based on total weight of the tungsten carbide portion-metal alloy powder blend.
15. The tungsten carbide portion-metal alloy powder blend of embodiment 14 wherein tungsten carbide portion is tungsten carbide, and the tungsten carbide-metal alloy powder blend comprises
about 50 wt % to about 95 wt % of tungsten carbide; and
about 5 wt % to about 50 wt % of the metal alloy, based on total weight of the tungsten carbide-metal alloy powder blend.
16. The tungsten carbide portion-metal alloy powder blend of embodiment 14, wherein the tungsten carbide portion is tungsten carbide, and tungsten carbide-metal alloy powder blend comprises
about 0.5 wt % to about 80 wt % of tungsten carbide; and
about 20 wt % to about 99.5 wt % of the metal alloy based on total weight of the tungsten carbide-metal alloy powder blend.
17. The tungsten carbide portion-metal alloy powder blend of embodiment 14, wherein tungsten carbide portion is tungsten carbide, and the tungsten carbide-metal alloy powder blend comprises
about 5 wt % to about 80 wt % of tungsten carbide; and
about 20 wt % to about 95 wt % of the metal alloy based on total weight of the tungsten carbide-metal alloy powder blend.
18. The tungsten carbide portion-metal alloy powder blend of embodiment 14, wherein the tungsten carbide portion is tungsten carbide, and tungsten carbide-metal alloy powder blend comprises
about 10 wt % to about 50 wt % of tungsten carbide; and
about 50 wt % to about 90 wt % of the metal alloy, based on total weight of the tungsten carbide-metal alloy powder blend.
19. A metal matrix composite (MMC) formed from the tungsten carbide portion-metal alloy powder blend of any one of embodiment 14 to 18.
20. A metal matrix composite (MMC) formed from the tungsten carbide portion-metal alloy powder blend of any one of embodiment 16 to 18, wherein the metal matrix composite is formed in situ by additively manufacturing the tungsten carbide portion-metal alloy powder blend using laser powder bed fusion (LPBF) additive manufacturing.
21. The metal matrix composite of embodiment 19 or embodiment 20, wherein the MMC product is a metalworking and machining product, an aerospace product, an automotive product, a tooling and manufacturing product, an electronic product, a semiconductor product or a medical product.
22. A laser powder bed fusion (LPBF) additively manufactured MMC product prepared from the tungsten carbide portion-metal alloy powder blend of any one of embodiment 16 to 18.
23. A laser powder bed fusion (LPBF) additively manufactured product prepared from metal alloy powder of any one of embodiment 1 to 13.
24. A method of LPBF additive manufacturing a metal matrix composite (MMC) product comprising:
providing a tungsten carbide portion-metal alloy powder blend of any one of embodiments 16 to 18 as a feedstock material in a LPBF apparatus, and
LPBF additively manufacturing the MMC product.
25. A method for reducing cracking and/or porosity of a LPBF additively manufactured MMC product comprising:
providing a tungsten carbide portion-metal alloy powder blend of any one of embodiments 13 to 16 as a feedstock material in a LPBF apparatus, and
LPBF additively manufacturing the MMC product.
26. A method of LPBF additive manufacturing a product comprising:
providing a metal alloy powder of any one of embodiments 13 to 16 as a feedstock material in a LPBF apparatus, and
LPBF additively manufacturing the product.

### EXAMPLES

The following non-limiting examples are illustrative of the present application.

### Example 1: Metal Mixture

Elemental Ni, Co, and Fe powders were mixed together by their respective weight percentages (about 44 wt % of Ni, about 28 wt % of Co; and about 28 wt % of Fe) to provide a metal mixture.

The metal mixture was used as feedstock material for LBPF printing. While the powders were spherical, it was unfortunately found that they did not flow well enough without further manipulation to spread evenly on the base plate for LPBF printing. For LPBF printing the powders should be both spherical and have good flowability. Lack of flowability of the binder mixture was confirmed by Hall flow meter.

### Example 2: Preparation and Characterization of Exemplary Metal Alloy Powder of the Application

### Preparation and Characterization of Exemplary Metal Alloy and Casted Rods of an Exemplary Metal Alloy

To try to increase flowability, a metal alloy was prepared from the metal mixture. Therefore, nickel (Ni), cobalt (Co) and iron (Fe) elemental powders were mixed together in a crucible by their respective weight percentages (about 44 atomic % of Ni, about 28 atomic % of Co; and about 28 atomic % of Fe) to provide a metal mixture powder as a feedstock. The metal mixture powder was placed in a vacuum arc furnace and casted into a multi principle element alloy (HPEA) as casted rods.

The casted rods were further heat treated at a soak temperature of about 1550° C. for about 1 hour.

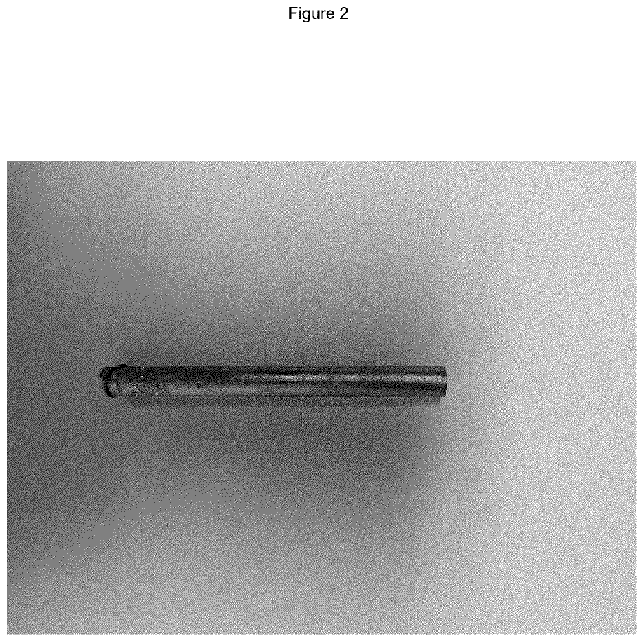

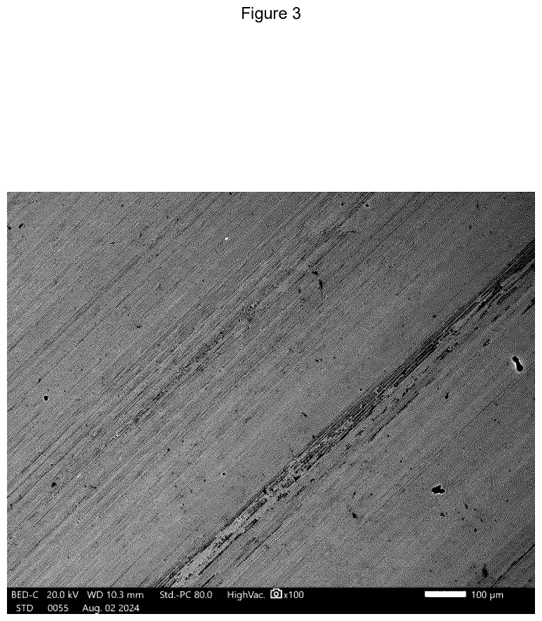

15 casted rods of the metal alloy were initially produced for characterization and initial atomization trials. FIG. 2 is a photo of an exemplary casted rod of an exemplary metal alloy of the application.

Initial scanning electron microscopy (SEM) analysis showed that the rods had a uniform composition, with no observable extra phases or segregation. FIG. 3 is a scanning electron microscopy (SEM) image of the casted rods.

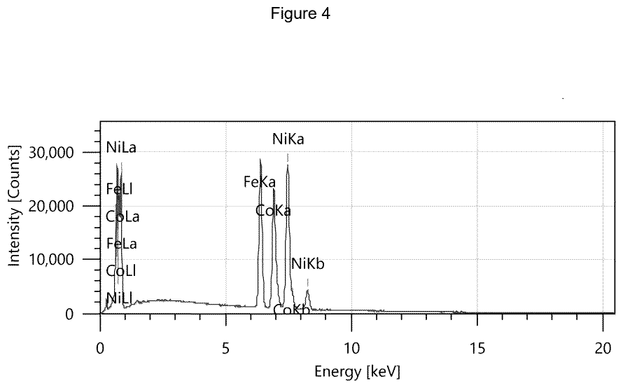

The casted rods were further analyzed using energy-dispersive X-ray spectroscopy (EDS). Table 3 and FIG. 4 show the results of the EDS analysis which showed that the composition of the casted rod metal alloy was very close to the desired metal alloy composition, which was about 28 atomic percent (at %) iron (Fe), about 28 at % cobalt (Co), and about 44 at % nickel (Ni).

TABLE 3

| Element | Line | Mass % | Atom % |
|---|---|---|---|
| Fe | K | 27.72 ± 0.05 | 28.77 ± 0.05 |
| Co | K | 28.45 ± 0.06 | 27.97 ± 0.06 |
| Ni | K | 43.83 ± 0.08 | 43.26 ± 0.08 |
| Total | | 100.00 | 100.00 |
| Spc_001 | | | Fitting ratio 0.0147 |

### Atomization of the Casted Rods

The casted rods were atomized into an exemplary metal alloy powder of the application. The casted rods were atomized by ultrasonic atomization (ATO Labs Ultrasonic Atomizer).

The resulting metal alloy powder was found to be very flowable, indicating that the atomization was effective.

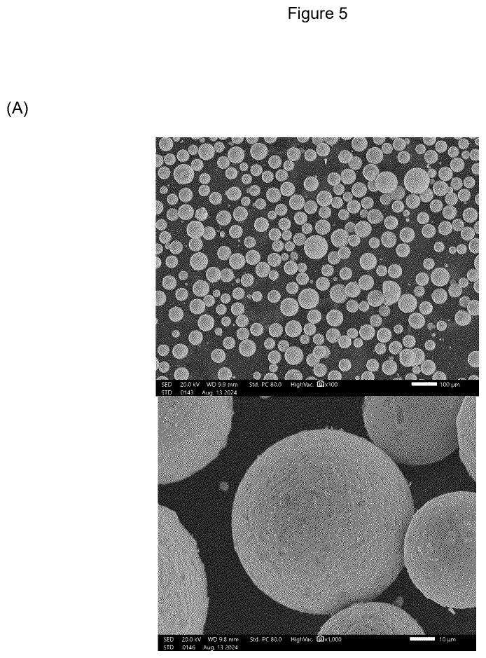

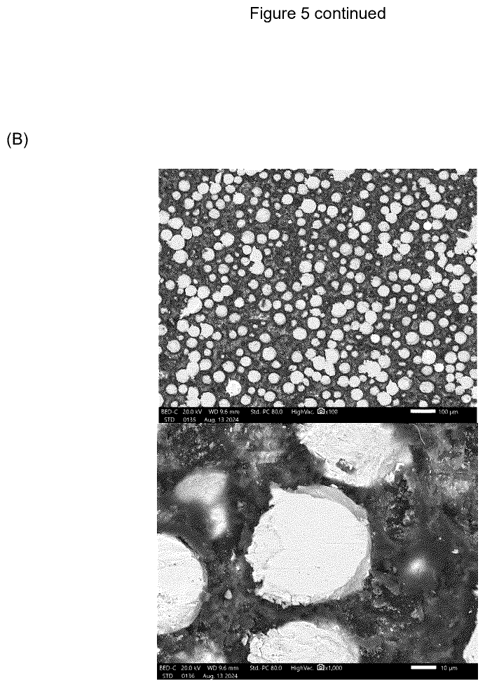

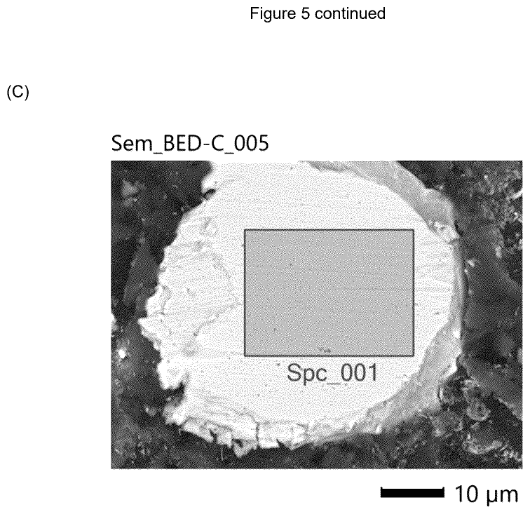

SEM analysis of the of metal alloy powder produced after atomization showed that uniform spherical powders were produced. FIG. 5A shows scanning electron microscopy (SEM) images of the metal alloy powder produced after atomization. FIG. 5 B shows scanning electron microscopy (SEM) images of a polished cross section of metal alloy powder particles. FIG. 5 C shows a magnified scanning electron microscopy (SEM) image of a polished cross section of a metal alloy powder particle.

EDS of the metal alloy powder once again showed that the composition of the metal alloy powder was very close to the desired metal alloy powder composition, which was about 28 atomic percent (at %) iron (Fe), about 28 atomic (at) % cobalt (Co), and about 44 at % nickel (Ni). Tables 4 and 5 show the results of the EDS of the metal alloy powder.

TABLE 4

| Element | Line | Mass % | Atom % |
|---|---|---|---|
| Si | K | 0.15 ± 0.01 | 0.31 ± 0.02 |
| Cr | K | 0.22 ± 0.01 | 0.24 ± 0.01 |
| Fe | K | 28.12 ± 0.05 | 29.12 ± 0.05 |
| Co | K | 28.14 ± 0.06 | 27.61 ± 0.06 |
| Ni | K | 43.36 ± 0.08 | 42.71 ± 0.08 |
| Total | | 100.00 | 100.00 |
| Spc_001 | | | Fitting ratio 0.0137 |

TABLE 5

at %

| Name | Si | Cr | Fe | Co | Ni |
|---|---|---|---|---|---|
| Spc_001 | 0.31 | 0.24 | 29.12 | 27.61 | 42.71 |
| Spc_002_1 | | 0.17 | 28.15 | 27.9 | 43.77 |
| Spc_006_1 | | 0.49 | 29.4 | 27.34 | 42.77 |
| Spc_007_1 | | 0.12 | 27.85 | 28.32 | 43.7 |
| Spc_008_1 | | 0.27 | 27.9 | 28.21 | 43.63 |
| Spc_009_1 | | 0.17 | 28.03 | 28.21 | 43.59 |

The Hall flow rate of the exemplary metal alloy powder of the application was measured and found to be about 13.2 seconds per 50 grams which is suitable for Laser Powder Bed Fusion (LPBF).

The metal alloy was sieved to a particle size of less than 100 micrometers (μm). The upper range of the particle size distribution was found to be larger than desired; therefore, the metal alloy powder was sieved to particle size of <63 μm. The further sieved metal alloy powder was found to have a particle size distribution comprising a D₁₀ of about 25.14 μm, a D₅₀ of about 42.45 μm, a D₉₀ of about 72.50 μm, a mean particle size of about 49.32 μm and a median particle size of about 42.45 μm.

### Example 3: Preparation and Characterization of Exemplary Tungsten Carbide-Metal Alloy Powder Blends of the Application

Tungsten carbide (WC) powder was purchased from Indurate Alloys Inc., (Alberta, Canada) and analyzed.

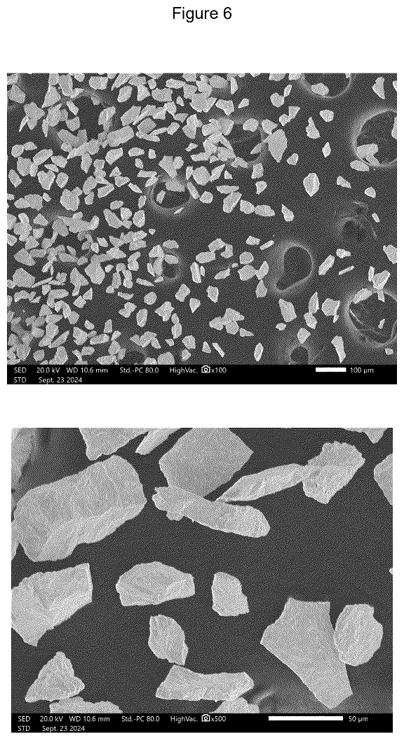

SEM imaging of the purchased WC powder showed that the WC powder particles had a non spherical structure (FIG. 6). Further, a sieve analysis of the WC powder indicated that out of 100 μm of sieved WC powder, the weight of the WC powder having a particle size of 45 μm or greater was 12.86 g, and the weight of the WC powder having a particle size of 45 μm or less was 81.73 g; therefore about 13.6% of the purchased WC powder was over the desired size.

WC powder as purchased was mixed with the exemplary metal alloy powder of Example 2 by planetary or ball milling.

Exemplary tungsten carbide-metal alloy powder blends with increasing amounts of tungsten carbide were prepared, and tested in the subsequent LPBF manufacturing studies described below.

### Example 4: LPBF Additive Manufactured Products Using Exemplary Metal Alloys and Tungsten Carbide-Metal Alloy Powder Blends

Exemplary metal alloy powders of the application and exemplary tungsten carbide-metal alloy powder blends with increasing amounts of tungsten carbide were prepared as described in Examples 2 and 3 respectively and used as feedstocks in the LPBF manufacturing of a cube using the following summary of design of experiments (DOE) and process parameters
Laser power [W]: about 200 to 250
Marking speed [mm/s]: about 500 to 1000
Hatching distance [μm]: about 50 to 100
Spot Size [μm]: about 40
Layer Thickness [μm]: about 50

At least 25 cubes were manufactured per trial using the above design of experiments (DOE) criteria and process parameters.

The density of the prepared cubes was measured using the Archimedes technique. Surface Roughness was measured using Keyence VR-5000, which uses a structured light scanning technique to approximate the surface roughness.

i. Trial with 100 wt % Metal Alloy Powder of Example 2

As an initial trial, exemplary metal alloys of Example 2 were used alone (without any tungsten carbide powder) as feedstock material for LPBP additive manufacturing of a cube using a broad process parameter.

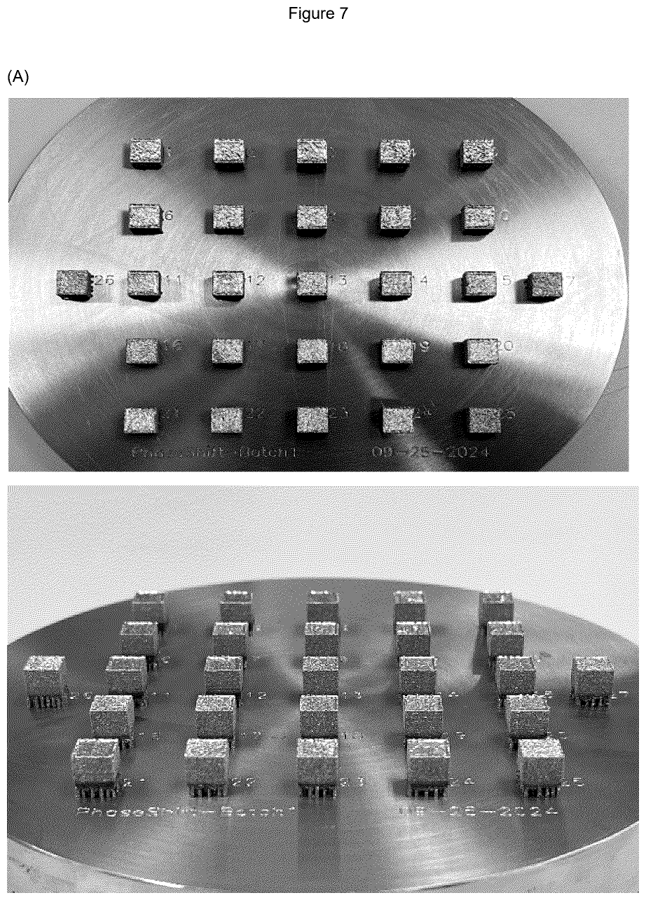

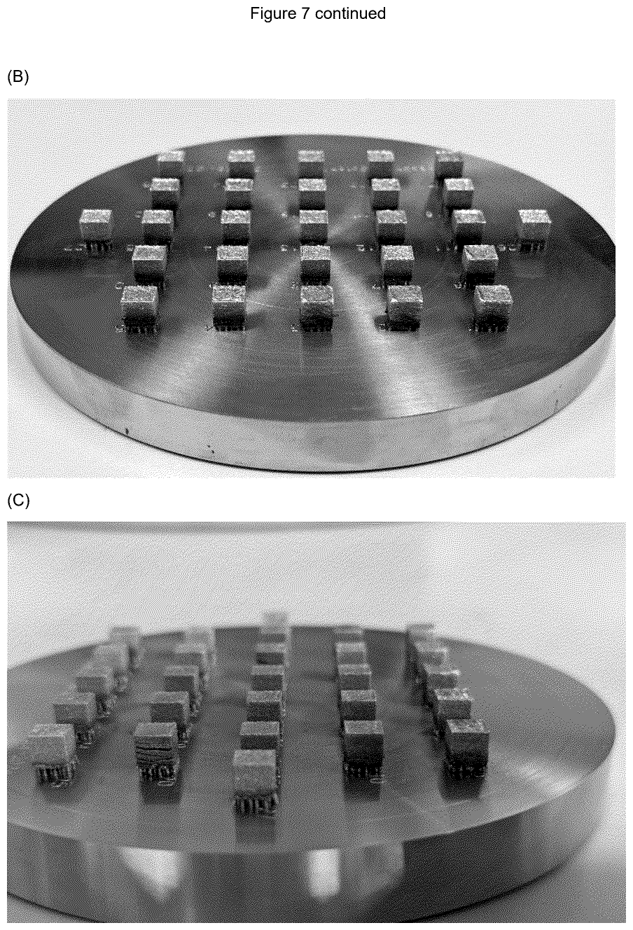

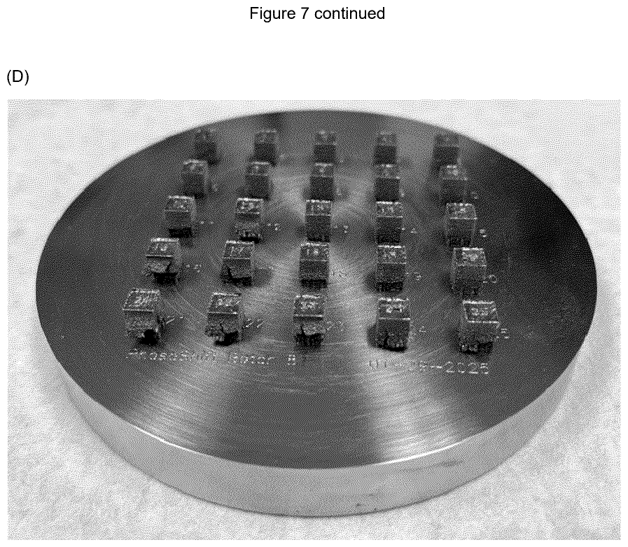

FIG. 7A shows images of the LPBF manufactured cubes using 100 wt % metal alloy powder of example 2. Very good density values were observed. No cracks or micro-cracks observed. Surface roughness was found to be typical of LPBF-printed samples. Micrograph analysis of a cross-section of select cubes, confirmed the observations.

ii. Trial with Increasing Amounts of Tungsten Carbide

Trials were next conducted with tungsten carbide-metal alloy blends of Example 3 with increasing amount of tungsten carbide. Preliminary trials with 10 wt % WC, 30 wt % WC and 50 wt % WC (two trials) were conducted using broad design of experiments (DOE) criteria described above.

a) Blend comprising 10 wt % WC: No cracking was observed. Densities of the resulting cubes were found to decrease compared to 100 wt % metal alloy. FIG. 7 B shows images of the LPBF manufactured cubes using blends with 10 wt % WC and the metal alloy powder of example 2.

b) Blend comprising 30 wt % WC: Minor surface cracks were observed in a few of the LPBF manufactured cubes. These cracks were not found to be present internally. Major crack were also observed to have major cracks in a couple of the LPBF manufactured. FIG. 7 C shows images of the LPBF manufactured cubes using blends with 30 wt % WC and the metal alloy powder of example 2

c) Blend comprising 50 wt % WC: Preliminary trials were conducted. The first trial was conducted using the broad process parameters, and cracking was observed such that some prints could not be completed. Subsequent trials were conducted using further optimized process parameters. Cubes were successfully printed using 50 wt % WC blend with the optimized process parameters. However, major cracks were observed in a few of the LPBF manufactured cubes. Nonetheless, LPBF manufactured cubes comprising 50 wt % WC were found to have very good density.

Micrograph analysis was used to confirm observed results.

Further optimization of process parameters and/or further processing of the WC is expected to improve printing results.

### Example 5: LPBF Additive Manufactured Products Using Exemplary Tungsten Carbide Portion-Metal Alloy Powder Blends

The WC was spray dried in combination with elemental Ni (90 wt % WC/10 wt % Ni) to form granules comprising WC and Ni.

Trials were next conducted with the blends prepared using the spray dried tungsten carbide/Ni granules and the metal alloy of example 2 with increasing amount of tungsten carbide.

Blend comprising 50 wt % of the 90 wt % WC/10 wt % Ni spray dried granules: Printing was successful. However, some cubes were observed to have cracks. FIG. 7 D shows images of the LPBF manufactured cubes using blends with 50 wt % of 90 wt % WC/10 wt % Ni and the metal alloy powder of example 2.

Further optimization of process parameters was expected to improve printing results, as shown below.

### Example 6: LPBF Additive Manufactured Products Using Exemplary Tungsten Carbide Portion-Metal Alloy Powder Blends with Increasing Amount of Tungsten

A metal alloy of the application comprising nickel (Ni), cobalt (Co) and iron (Fe) elemental powders was prepared similar to the process of Example 2 except the metal alloy was atomized using commercial scale gas atomization process (Surface Engineering Alloy Co. St. Petersburg, U.S).

Chemical analysis of the resulting gas atomized metal alloy powder by ICP-OES with interstitials measured by LECO combustion/inert-gas fusion per ASTM classification standard ASTM E2594 (ASTM International, West Conshohocken, PA) showed that the composition of the metal alloy powder to comprise about 26 weight percent (wt %) iron (Fe), about 28 weight (wt) % cobalt (Co), and about 46 wt % nickel, and further about 0.05 wt % carbon (C), 0.1 wt % manganese (Mn) and 0.01 wt % silicon as shown in Table 6.

TABLE 6
Chemical Analysis
Chemical Analysis -% by Weight

| C | Mn | Si | Cr | Ni | Mo | W | Fe | Co | P | S | Cu |
|---|---|---|---|---|---|---|---|---|---|---|---|
| 0.05 | 0.1 | 0.01 | | BAL | | | 26 | 28 | | | |
| Nb + Ta | Al | V | Ti | B | N | O | Zr | Nb | Zn | Ag | Cd |

| | | | | |
|---|---|---|---|---|
| Sb | Pb | Sn | As | Other elements |

The Hall flow rate of the exemplary metal alloy powder was measured and found to be about 12.2 seconds per 50 g.

The apparent density of the exemplary metal alloy powder was measured and found to be about 4.65 g/cc as measured by Hall funnel methods by ASTM classification standards ASTM B213 and ASTM B212 (ASTM International, West Conshohocken, PA).

A sieve analysis of the metal alloy was further conducted. Results are provided in Table 7

TABLE 7
Sieve analysis - % by weight - US Standard - micron
Sieve analysis - % by weight - US Standard - micron

| Sieve Notation | Sieve Opening (μm) | % Retained |
|---|---|---|
| +270 | 53 | 1.6% |
| +325 | 43 | 24.5% |
| +400 | 38 | 36.3% |
| +450 | 32 | 20.5% |
| +500 | 25 | 14.5% |
| +635 | 20 | 1.8% |

From Table 7, it can be seen that about 98% of the particles were smaller that 53 μm, about 90% of the particles were smaller than about 49 μm, about 50% of the particles were smaller than about 40 μm and about 10% of the particles were smaller than about 28 μm.

A Ni spray coated WC powder for additive manufacturing was purchased from WallColMonoy Surfacing Alloys, WallCarb™ 90/10 (WC-10Ni). WallCarb™ 90/10 comprises about 90 wt % WC and about 10 wt % Ni, has a Hall flow of about 13.55 sec per 50 g (ASTM classification standard, ASTM B213, (ASTM International, West Conshohocken, PA)) and an apparent density of about 4.5 g/cc (ASTM classification standard, ASTM B212, (ASTM International, West Conshohocken, PA)). WallCarb™ 90/10 is spherical, spray dried and sintered, and has a sieve analysis (particle size distribution) using ASTM classification standards ASTM B214 or ASTM B822 (ASTM International, West Conshohocken, PA) as shown in Table 8.

TABLE 8
sieve analysis (particle size distribution) of Ni spray coated
WC powder, WallCarb ™ 90/10
Sieve analysis

| microns | Wt % |
|---|---|
| −45 + 38 | 0.35 |
| −45 + 38 | 29.35 |
| −38 + 20 | 69.63 |
| −20 + 15 | 0.66 |
| −15 | 0 |

WC portion-metal alloy powder blends using the metal alloy powder and comprising increasing amounts Ni spray coated WC powder (WallCarb™ 90/10) were prepared. In particular, blends comprising 50 wt % and 65 wt % Ni spray coated WC powder (WallCarb™ 90/10) were prepared and tested.

The target application of the blends was the printing of nozzles for use in the oil and gas industry. Results using a WC portion-metal alloy powder blend of 65 wt % Ni spray coated WC powder (WallCarb™ 90/10) showed hardness and wear resistance that was appropriate for the application. The increase in WC positively correlated with these properties. Therefore, blends with further increasing amounts of Ni spray coated WC powder (WallCarb™ 90/10) were not tested. Moreover, while not being bound by theory, it would be expected that increasing the WC portion considerably beyond 65 wt % would not be suitable for LPBF manufacturing. Further increasing the WC portion would likely provide LPBF manufactured MMCs with increasing hardness but decreased toughness, and therefore prone to cracking.

It should be noted that the WC portion-metal alloy powder blends comprising lower amounts of WC/WC portion also printed well, and would be useful in other applications where those hardness values would be suitable.

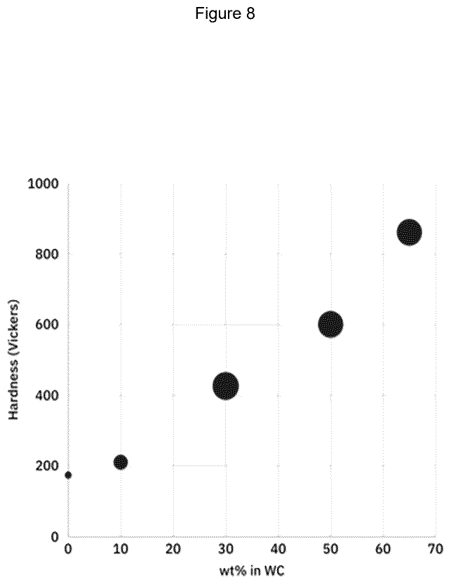

FIG. 8 shows the microhardness values for the LPBF manufactured MMCs using various exemplary WC portion-metal alloy powder blends of the application with increasing WC content. The measurements were determined using a Struers DuraScan for micro-hardness tested in accordance with ASTM classification standard, ASTM E384 (ASTM International, West Conshohocken, PA) In particular, FIG. 8 shows the hardness of LPBF manufactured MMCs using exemplary metal allow powder alone of Example 4 (i.e., 0% WC), 10 wt % WC-metal alloy powder of Example 4, 30 wt % WC-metal alloy powder of Example 4, 50 wt % Ni spray coated WC powder (WallCarb™ 90/10)-metal alloy powder and 65 wt % Ni spray coated WC powder (WallCarb™ 90/10)-metal alloy powder. As can be seen from FIG. 8, the hardness increases with increasing WC content.

### Example 7: Evaluation of 65 wt % Ni Spray Coated WC Powder (WallCarb™ 90/10)-Metal Allow Powder and LPBF Manufactured MMCs Produced Using Same

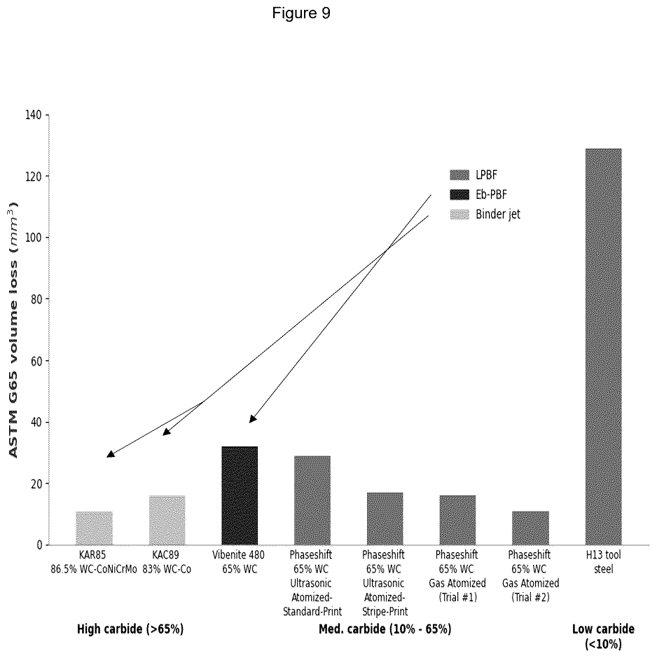

FIG. 9 shows the wear testing results (as determined in accordance with ASTM classification standard, ASTM G65, ASTM International, West Conshohocken, PA) for LPBF manufactured MMCs prepared using an exemplary 65 wt % Ni spray coated WC powder (WallCarb™ 90/10)-metal alloy powder blend using the ultrasonic atomized metal alloy powder of example 2 and an exemplary 65 wt % Ni spray coated WC powder (WallCarb™ 90/10)-metal alloy powder blend using the commercially gas atomized metal alloy powder of example 6, and compared to commercially available tungsten carbide material Kar85™ (Kennametal) comprising 86.4% WC-CoNiCrMo, KAC89™ (Kennametal, Pittsburgh, US) comprising 83% WC-Co, Vibenite™ 480 (VBN Components, Sweden) comprising 65 wt % WC and also to H13 tool steel. In particular, FIG. 9 shows the comparative wear testing results for Kar85™ (first column), KAC89™ (second column), Vibenite™ 480 (third column), LPBF manufactured MMCs using an exemplary 65 wt % Ni spray coated WC powder (WallCarb™ 90/10)-ultrasonically atomized metal alloy powder blend (fourth and fifth column), LPBF manufactured MMCs using an exemplary 65 wt % Ni spray coated WC powder (WallCarb™ 90/10)-commercially gas atomized metal alloy powder blend (sixth and seventh column), and H13 tool steel (eight column).

Lower numbers mean lower the volume loss, and are thus desired. Wear resistance would be important, for example, in the oil sands industry which operates under an abrasive environment. As can be seen from FIG. 9, the 65 wt % Ni spray coated WC powder (WallCarb™ 90/10)-metal alloy powder blends of the application performed better than other material comprising 65 wt % WC (Vibenite 480) and performed comparably or better to material comprise higher amounts of WC (Kar85 ad KAC89).

### Example 8: LPBF Manufactured MMCs Using 65 wt % Ni Spray Coated WC Powder (WallCarb™ 90/10)-Metal Allow Powder and LPBF Manufactured MMCs Produced Using Same

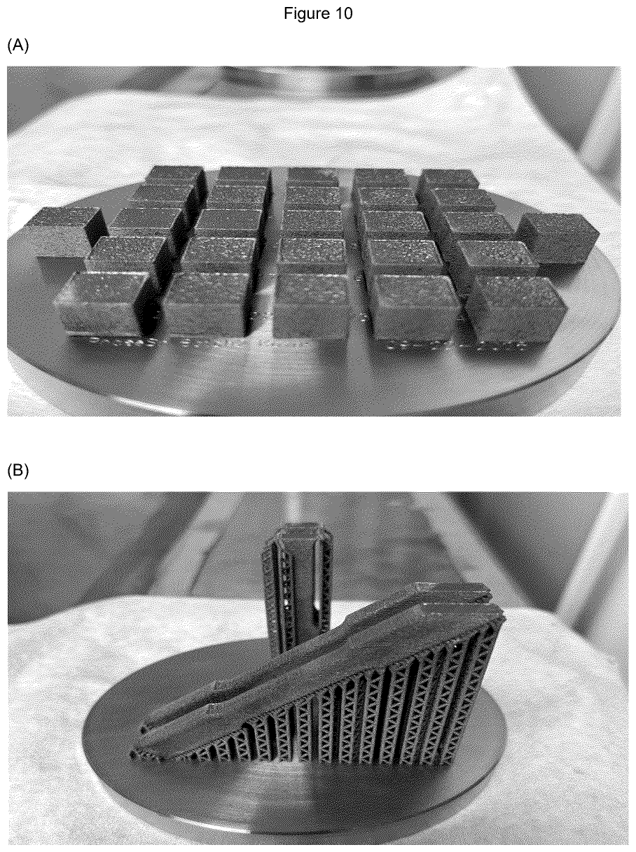

LPBF manufactured MMCs using 65 wt % Ni spray coated WC powder (WallCarb™ 90/10)-gas atomized metal alloy blends of example 6 were investigated. LPBF manufactured MMCs having cubic geometries (FIG. 10 (A)) were first printed to optimize process parameters. Each cube was tested for its relative density as determined using the Archimedes method and printing optimized accordingly. Table 9 shows the density measurements of each cube.

TABLE 9

| | Laser | Marking | Hatching | | |
|---|---|---|---|---|---|
| | power [W] | speed [mm/s] | distance [μm] | Density | VED |
| 1 | 200 | 300 | 30 | 100.0 | 444 |
| 2 | 225 | 300 | 30 | 98.8 | 500 |
| 3 | 250 | 300 | 30 | 98.6 | 556 |
| 4 | 200 | 450 | 30 | 96.3 | 296 |
| 5 | 225 | 450 | 30 | 96.3 | 333 |
| 6 | 250 | 450 | 30 | 98.9 | 370 |
| 7 | 200 | 600 | 30 | 93.4 | 222 |
| 8 | 225 | 600 | 30 | 95.6 | 250 |
| 9 | 250 | 600 | 30 | 95.5 | 278 |
| 10 | 200 | 300 | 40 | 97.8 | 333 |
| 11 | 225 | 300 | 40 | 96.6 | 375 |
| 12 | 250 | 300 | 40 | 98.0 | 417 |
| 13 | 200 | 450 | 40 | 97.0 | 222 |
| 14 | 225 | 450 | 40 | 97.3 | 250 |
| 15 | 250 | 450 | 40 | 97.8 | 278 |
| 16 | 200 | 600 | 40 | 93.8 | 167 |
| 17 | 225 | 600 | 40 | 95.4 | 188 |
| 18 | 250 | 600 | 40 | 98.0 | 208 |
| 19 | 200 | 300 | 50 | 98.6 | 267 |
| 20 | 225 | 300 | 50 | 96.5 | 300 |
| 21 | 250 | 300 | 50 | 100.4 | 333 |
| 22 | 200 | 450 | 50 | 94.4 | 178 |
| 23 | 225 | 450 | 50 | 98.3 | 200 |
| 24 | 250 | 450 | 50 | 98.2 | 222 |
| 25 | 200 | 600 | 50 | 93.2 | 133 |
| 26 | 225 | 600 | 50 | 95.0 | 150 |
| 27 | 250 | 600 | 50 | 95.2 | 167 |

As can be seen from the density in Table 9, the resulting cubes had very high Archimedes density values which are consistent with effective melting and wetting of the exemplary blend of the application, uniform solidification, strong layer fusion and low porosity, showing that the exemplary blends are well-suited for additive manufacturing.

Resulting summary of design of experiments (DOE) and process parameters are as below
Laser power [W]: about 225 to 250
Marking speed [mm/s]: about 300 to 450
Hatching distance [μm]: about 30 to 50
Spot Size [μm]: about 40
Layer Thickness [μm]: about 50

Optimized parameters were then used to print larger designs (FIG. 10 (B)). Microstructural images indicated that the LPBF manufactured MMCs were crack free.

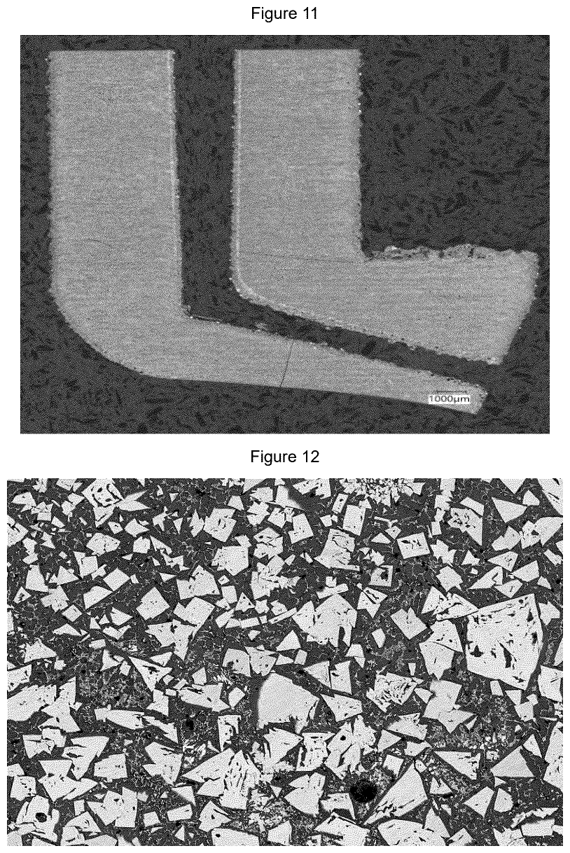

A nozzle was ultimately printed. FIG. 11 shows the scanning electron microscope image of the cross section of the printed nozzle, captured using a JEOL JSM-IT710HR instrument. As can be seen, this image shows a crack free print even for the larger samples which is significant for field applications. FIG. 12 shows an as-printed microstructure of the nozzle obtained using JEOL JSM-IT710HR scanning electron microscope. The lighter regions are the WC particles and dark continuous phase shows the FCC matrix.

While the present application has been described with reference to examples, it is to be understood that the scope of the claims should not be limited by the embodiments set forth in the examples, but should be given the broadest interpretation consistent with the description as a whole.

All publications, patents and patent applications are herein incorporated by reference in their entirety to the same extent as if each individual publication, patent or patent application was specifically and individually indicated to be incorporated by reference in its entirety. Where a term in the present application is found to be defined differently in a document incorporated herein by reference, the definition provided herein is to serve as the definition for the term.

1.-13. (canceled)

14. A hard component portion-metal alloy powder blend comprising:
about 0.5 wt % to about 95 wt % of a hard component portion; and
about 5 wt % to about 99.5 wt % of a metal alloy,
wherein the metal alloy comprises at least about 40 weight (wt) % of nickel (Ni) but not more than about 48 wt % of nickel (Ni), at least about 26 wt % of cobalt (Co) and at least about 26% wt % of iron (Fe), and
wherein all wt % are based on total weight of the hard component portion-metal alloy powder blend.

15. The hard component portion-metal alloy powder of claim 14, comprising
about 50 wt % to about 95 wt % of the hard component portion; and
about 5 wt % to about 50 wt % of the metal alloy, wherein all wt % based on total weight of the hard component portion-metal alloy powder blend.

16. The hard component portion-metal alloy powder blend of claim 14, comprising
about 0.5 wt % to about 70 wt % of the hard component portion, and
about 30 wt % to about 99.5 wt % of the metal alloy,
wherein all wt % based on total weight of the hard component portion-metal alloy powder blend.

17. The hard component portion-metal alloy powder blend of claim 16, wherein the hard component portion-metal alloy powder blend comprises about 1 wt % to about 70 wt %, about 5 wt % to about 70 wt %, about 10 wt % to about 70 wt %, about 20 wt % to about 70 wt %, about 30 wt % to about 70 wt %, about 40 wt % to about 70 wt %, about 50 wt % to about 70 wt %, about 60 wt % to about 70 wt %, about 65 wt % to about 70 wt %, about 0.5 wt % to about 65 wt %, about 1 wt % to about 65 wt %, about 5 wt % to about 65 wt %, about 10 wt % to about 65 wt %, about 20 wt % to about 65 wt %, about 30 wt % to about 65 wt %, about 40 wt % to about 65 wt %, about 50 wt % to about 65 wt %, about 60 wt % to about 65 wt % of the hard component portion based on total weight of the hard component portion-metal alloy powder blend.

18. The hard component portion-metal alloy powder blend of claim 16, wherein the hard component portion-metal alloy powder blend comprises
about 0.5 wt % to about 65 wt % of the hard component portion; and
about 35 wt % to about 99.5 wt % of the metal alloy, wherein all wt % based on total weight of the hard component portion-metal alloy powder blend.

19. The hard component portion-metal alloy powder blend of claim 16, wherein the hard component portion comprises about 75 wt % to about 95 wt % of a hard component and about 5 wt % to about 25 wt % of the metal alloy, or one or more elemental metals selected from Ni, Co and Fe, or mixtures thereof, wherein all wt % are based on the total weight of the hard component portion.

20. The hard component portion-metal alloy powder blend of claim 19, wherein the hard component portion comprises about 80 wt % to about 95 wt % of the hard component, and about 5 wt % to about 15 wt % of elemental Ni, wherein all wt % are based on the total wt % of the hard component portion.

21. The hard component portion-metal alloy powder blend of claim 16, wherein the hard component portion-metal alloy powder blend comprises
about 0.5 wt % to about 70 wt % of the hard component portion, based on total weight of the hard component portion-metal alloy powder blend; and
about 30 wt % to about 99.5 wt % of the metal alloy, based on total weight of the hard component-metal alloy powder blend, and
wherein the hard component portion comprises about 85 wt %, about 90 wt % or about 95 wt % of a hard component and about 5 wt %, about 10 wt % or about 15 wt % of elemental Ni, based on the total wt of the hard component portion.

22. The hard component portion-metal alloy powder blend of claim 16, wherein the hard component portion-metal alloy powder blend comprises
about 0.5 wt % to about 65 wt % of the hard component portion, based on total weight of the hard component portion-metal alloy powder blend; and
about 35 wt % to about 99.5 wt % of the metal, based on total weight of the hard component portion-metal alloy powder blend,
wherein the hard component portion comprises about 85 wt %, about 90 wt % or about 95 wt % of a hard component and about 5 wt %, about 10 wt % or about 15 wt % of elemental Ni, based on the total weight of the hard component portion.

23. The hard component portion-metal alloy powder blend of claim 22, wherein the hard component portion comprises about 90 wt % of the hard component and about 10 wt % elemental Ni, based on the total weight of the hard component portion.

24. The hard component portion-metal alloy powder blend of claim 16, wherein the hard component portion comprises a hard component only.

25. The hard component portion-metal alloy powder blend of claim 16, wherein the hard component is tungsten carbide.

26. The hard component portion-metal alloy powder blend of claim 22, wherein the hard component is tungsten carbide.

27. (canceled)

28. (canceled)

29. A method of preparing a metal matrix composite comprising:
providing the hard component portion-metal alloy powder blend of claim 16 as a feedstock material in a LPBF apparatus, and
LPBF additively manufacturing the metal matrix composite.

30. The hard component portion-metal alloy powder blend of claim 14, wherein the metal alloy comprises
about 38 wt % to about 50 wt % of Ni;
about 25 wt % to about 31 wt % of Co; and
about 25 wt % to about 31 wt % of Fe,
wherein all wt % are based on the total weight of the metal alloy.

31. The hard component portion-metal alloy powder blend of claim 30, wherein the metal alloy comprises about 40 wt % to about 48 wt % Ni, wherein all wt % are based on the total weight of the metal alloy.

32. The hard component portion-metal alloy powder blend of claim 30, wherein the metal alloy comprises about 25 wt % to about 30 wt % Co, wherein all wt % are based on the total weight of the metal alloy.

33. The hard component portion-metal alloy powder blend of claim 30, wherein the metal alloy comprises about 25 wt % to about 30 wt % Fe, wherein all wt % are based on the total weight of the metal alloy.

34. The hard component portion-metal alloy powder blend of claim 30, wherein the metal alloy comprises
about 40 wt % to about 48 wt % of Ni;
about 25 wt % to about 30 wt % of Co; and
about 25 wt % to about 30 wt % of Fe, all wt % based on the total weight of the metal alloy.

35. The hard component portion-metal alloy powder blend of claim 30, wherein the metal alloy comprises
about 44 wt % to about 48 wt % of Ni;
about 25 wt % to about 28 wt % of Co; and
about 25 wt % to about 28 wt % of Fe, all wt % based on the total weight of the metal alloy.

36. The hard component portion-metal alloy powder blend of claim 30, wherein the metal alloy comprises
about 44 wt % to about 46 wt % of Ni;
about 26 wt % to about 28 wt % of Co; and
about 26 wt % to about 28 wt % of Fe, wherein all wt % based on the total weight of the metal alloy.

37. The hard component portion-metal alloy powder blend of claim 30, wherein the metal alloy is heat treated.

38. The hard component portion-metal alloy powder blend of claim 30, wherein the metal alloy comprises a D₅₀ of about 35 μm to about 45 μm.

39. The hard component portion-metal alloy powder blend of claim 30, wherein the metal alloy comprises a Hall flow rate of about 14 seconds or less, about 13 seconds or less, or about 12 seconds or less.

40. The hard component portion-metal alloy powder blend of claim 30, wherein the metal alloy powder comprises an apparent density of about 3.5 g/cc to about 5.5 g/cc.

41. The hard component portion-metal alloy powder blend of claim 30, wherein the metal alloy has an alloy purity of at least 98 wt %, at least 99 wt %, at least 99.1 wt %, at least 99.2 wt %, at least 99.3 wt %, at least 99.4 wt %, or at least 99.5 wt %, wherein all wt % are based on the total weight of the metal alloy.
